(19) United States
(12) Patent Application Publication
(10) Pub. No.: US 2026/0142094 A1
(43) Pub. Date: May 21, 2026

(54) Low Profile Soid Electrolytic Capacitor

(71) Applicant: KYOCERA AVX Components Corporation, Fountain Inn, SC (US)

(72) Inventors: Naomi Lollis, Honea Path, SC (US); Jan Petrzilek, Usti nad Orlici (CZ); Miloslav Uher, Lanskroun (CZ)

(21) Appl. No.: 19/393,687

(22) Filed: Nov. 19, 2025

Related U.S. Application Data
(60) Provisional application No. 63/722,618, filed on Nov. 20, 2024.

(51) Int. Cl. H01G 9/15; H01G 9/00; H01G 9/028; H01G 9/04; H01G 9/042; H01G 9/052; H01G 9/07; H01G 9/08

(52) U.S. Cl. CPC H01G 9/15; H01G 9/0032; H01G 9/0036; H01G 9/028; H01G 9/0425; H01G 9/0525; H01G 9/07; H01G 9/08; H01G 2009/05

(57) ABSTRACT

A solid electrolytic capacitor having a thickness of about 1,000 μm or less is provided. The capacitor comprises a capacitor element comprising an anode component comprising a porous anode body disposed on a surface of an anode substrate. The anode substrate is formed from a valve metal composition and the porous anode body is formed from a sintered powder containing a valve metal composition and having a thickness of about 650 μm or less. The capacitor element further comprises a cathode coating disposed over a dielectric and the porous anode body. The cathode coating comprises a solid electrolyte containing conductive polymer particles, wherein at least a region of the anode substrate is free of the cathode coating. An anode termination is electrically connected to the region of the anode substrate that is free of the cathode coating, and a cathode termination is electrically connected to the cathode coating.

### RELATED APPLICATION

The present application is based upon and claims priority to U.S. Provisional Patent Application Ser. No. 63/722,618, having a filing date of Nov. 20, 2024, which is incorporated herein by reference.

### BACKGROUND OF THE INVENTION

Emerging applications in various electronic and medical fields require miniaturized capacitors with relatively high densities and high volumetric efficiencies. Implantable medical applications, for example, currently demand high capacitance densities in combination with a high rated voltage and frequency range. Silicon trench capacitors have been developed that attempt to leverage the fundamental parameter of enhancement in surface area to increase capacitance density. While suitable in some cases, however, silicon trench capacitors fail to meet the requirements for many applications because they cannot provide the combination of a high capacitance density and volumetric efficiency. This is primarily because the depth of the trench has a direct correlation to capacitance density. In other words, higher capacitance requires a deeper trench and thus an increase in volume. As such, a need currently exists for a capacitor that is capable of achieving a high capacitance density while still achieving the desired volumetric efficiency for high density applications.

### SUMMARY OF THE INVENTION

In accordance with one embodiment of the present invention, a solid electrolytic capacitor is disclosed that has a thickness of about 1,000 μm or less. The capacitor comprises a capacitor element comprising an anode component comprising a porous anode body disposed on a surface of an anode substrate. The anode substrate is formed from a valve metal composition and the porous anode body is formed from a sintered powder containing a valve metal composition. The anode component has a thickness of about 650 μm or less. The capacitor element further comprises a dielectric disposed over the porous anode body and a cathode coating disposed over the dielectric and the porous anode body. The cathode coating comprises a solid electrolyte containing conductive polymer particles, wherein at least a region of the anode substrate is free of the cathode coating. An anode termination is electrically connected to the region of the anode substrate that is free of the cathode coating, and a cathode termination is electrically connected to the cathode coating. A casing seals the capacitor element and leaves exposed at least a portion of the anode termination and the cathode termination.

In accordance with another embodiment of the present invention, a method for forming a capacitor element having a thickness of about 700 μm or less is disclosed. The method comprises depositing a tantalum powder onto a surface of a tantalum foil and sintering the powder to form a porous anode body; forming a dielectric over the porous anode body; applying a masking material to the anode substrate in a predetermined pattern such that the porous anode body remains uncovered with the masking material; and forming a cathode coating over the dielectric and the porous anode body such that at least a region of the anode substrate is free of the cathode coating, wherein the cathode coating comprises a solid electrolyte containing conductive polymer particles.

Other features and aspects of the present invention are set forth in greater detail below.

### BRIEF DESCRIPTION OF THE FIGURES

A full and enabling disclosure of the present invention to one skilled in the art, including the best mode thereof, is set forth more particularly in the remainder of the specification, including reference to the accompanying figures, in which:

FIG. 1 is a cross-sectional view of one embodiment of an anode component that may be employed in the solid electrolytic capacitor of the present invention;

FIG. 2 is a cross-sectional view of one embodiment of an anode component that may be employed in the solid electrolytic capacitor of the present invention;

FIG. 3 is a cross-sectional view of one embodiment of an anode component that may be employed in the solid electrolytic capacitor of the present invention;

FIG. 4 is a cross-sectional view of one embodiment of the solid electrolytic capacitor of the present invention;

FIG. 5 is a cross-sectional view of another embodiment of the solid electrolytic capacitor of the present invention; and

FIGS. 6-7 are flow charts illustrating one embodiment of a method of forming a capacitor element of the solid electrolytic capacitor of the present invention.

Repeat use of reference characters in the present specification and in different figures is intended to represent the same or analogous features or elements.

### DETAILED DESCRIPTION

It is to be understood by one of ordinary skill in the art that the present discussion is a description of exemplary embodiments only and is not intended as limiting the broader aspects of the present invention.

Generally speaking, the present disclosure is directed to a solid electrolytic capacitor that can occupy a low profile on the surface of a circuit component and/or be embedded within the component. More particularly, the thickness (or height) of the capacitor is relatively low, such as about 1,000 micrometers (“μm”) or less, in some embodiments from about 1 μm to about 800 μm, in some embodiments from about 50 μm to about 750 μm, and in some embodiments, from about 100 μm to about 600 μm. To help achieve such a low profile, the capacitor contains a capacitor element that includes an anode component. The anode component in turn includes a porous anode body disposed on at least one surface of an anode substrate (e.g., foil, wafer, sheet, etc.). The thickness of the anode component is typically about 500 μm or less, in some embodiments from about 10 μm to about 300 μm, in some embodiments from about 20 μm to about 200 μm, and in some embodiments, from about 30 μm to about 150 μm.

Conventionally, capacitors (and anode components) having such a low profile often had poor electrical properties that make it difficult to employ them in applications requiring high voltages and/or high frequencies. Without intending to be limited by theory, the present inventors have discovered that through selective control over the particular nature of the materials and assembly processes, the resulting capacitor may exhibit excellent electrical properties over a wide variety of conditions. For example, the capacitor may exhibit a leakage current (“DCL”) of about 400 microamps (“A”) or less, in some embodiments about 350 μA or less, and in some embodiments, from about 1 to about 300 μA, as determined at a temperature of 23° C. Notably, this leakage current may remain stable above even after being exposed to a high temperature, such as from about 80° C. or more, in some embodiments from about 100° C. to about 150° C., and in some embodiments, from about 105° C. to about 130° C. (e.g., 105° C. or 125° C.) for a substantial period of time, such as for about 100 hours or more, and in some embodiments, from about 150 hours to about 3,000 hours (e.g., 1,000 or 3,000 hours). In one embodiment, for example, the leakage current after being exposed to the high temperature (e.g., 105° C.) for 1,000 hours (“accelerated life leakage current”) remains within the ranges noted above. The ratio of the accelerated life leakage current to the initial leakage current (e.g., at 23° C.) prior to such testing may also be from about 0.7 to 1, in some embodiments from about 0.8 to 1, in some embodiments from about 0.9 to 1, and in some embodiments, from 0.91 to 0.99.

In addition to leakage current stability, the capacitor may also exhibit other good electrical properties. The breakdown voltage may, for example, be about 50 V or more, in some embodiments about 55 V or more, in some embodiments about 60 V or more, in some embodiments about 65 volts or more, in some embodiments about 70 V or more, in some embodiments from about 80 V to about 200 V, and in some embodiments, from about 90 to about 150 V. The capacitor may also exhibit a capacitance density of about 30 nanoFarads per square centimeter (“nF/cm²”) or more, in some embodiments about 100 nF/cm² or more, in some embodiments from about 200 to about 3,000 nF/cm², and in some embodiments, from about 400 to about 2,000 nF/cm², measured at a frequency of 120 Hz at temperature of 23° C. The actual capacitance may vary, such as from about 10 μF to about 1,000 μF, in some embodiments from about 50 μF to about 500 μF, and in some embodiments, from about 60 μF to about 250 μF.

Due to its ability to provide good electrical performance, the resulting capacitor may be uniquely positioned to provide robust broadband decoupling and high-speed switching. The capacitor may also exhibit excellent DC power filtering, such as illustrated by excellent attenuation over a broad range of frequencies. As known in the art, insertion loss measures power transfer between terminations, if the power increases, gain is exhibited, where if power is decreased between the terminals, attenuation is exhibited. Thus, the capacitor may exhibit high attenuation over a broad frequency range, allowing a broad range of frequencies to be well filtered. For instance, the capacitor may exhibit about attenuation (S₂₁ parameter) of about 15 dB or more, in some embodiments about 25 dB or more, in some embodiments about 30 dB or more, in some embodiments from about 35 dB to about 70 dB, and in some embodiments, from about 50 dB to about 70 dB. Such attenuation may be exhibited over a wide frequency range. For example, at low frequencies ranging from about 0.1 MHz to about 500 MHz, and in some cases, from about 1 MHz to about 100 MHz, the capacitor may exhibit attenuation (S₂₁ parameter) of about 40 dB or more, in some embodiments about 50 dB or more, in some embodiments about 55 dB or more, and in some embodiments, from about 60 dB to about 70 dB. Likewise, at high frequencies ranging from about 500 MHz to about 10 GHZ, and in some cases from about 1 GHz to about 5 GHz, the capacitor may exhibit attenuation (S₂₁ parameter) of about 20 dB or more, in some embodiments about 25 dB or more, in some embodiments about 30 dB or more, and in some embodiments, from about 30 dB to about 60 dB. Among other things, such attenuation may allow the capacitor to be readily employed in DC power filtering applications. Furthermore, the capacitor may perform consistently across a wide range of temperatures. For instance, in one embodiment, the capacitor may vary about 5 dB or less over a large temperature range, such as a change in temperature of about 25° C. or greater, in some embodiments about 50° C., or greater, and in some embodiments, about 70° C. or greater.

Various embodiments of the capacitor will now be described in more detail herein.

### I. Capacitor Element

### A. Anode Component

As indicated, the anode component contains an anode substrate on which is disposed a porous anode body. The anode substrate is typically formed from a material that is generally impervious to liquids and that is generally planar in nature, such as a wafer, foil, tape, sheet, etc. The substrate may generally be electrically conductive and made of a material that is compatible with the porous anode body. For example, the substrate may contain a valve metal composition that includes a valve metal (e.g., a metal that is capable of oxidation) or a valve metal-based compound, such as tantalum, niobium, aluminum, hafnium, titanium, alloys thereof, oxides thereof, nitrides thereof, and so forth. For example, the valve metal may contain an electrically conductive oxide of niobium, such as niobium oxide having an atomic ratio of niobium to oxygen of 1:1.0±1.0, in some embodiments 1:1.0±0.3, in some embodiments 1:1.0±0.1, and in some embodiments, 1:1.0±0.05. The niobium oxide may be NbO_{0.7}, NbO_{1.0}, NbO_{1.1}, and NbO₂. In one particular embodiment, the valve metal composition contains tantalum. The size of the substrate may vary as desired. In one embodiment, for example, the substrate (e.g., foil) may have a thickness of about 150 μm or less, in some embodiments from about 0.5 μm to about 120 μm, in some embodiments from about 1 μm to about 100 μm, and in some embodiments, from about 5 μm to about 50 μm.

The anode body is also typically formed from a powder that contains a valve metal composition, such as a valve metal (e.g., tantalum) or valve metal-based compound (e.g., niobium monoxide). In one embodiment, for instance, the valve metal powder is formed from tantalum. If desired, a reduction process may be employed in which a tantalum salt (e.g., potassium fluorotantalate (K₂TaF₇), sodium fluorotantalate (Na₂TaF₇), tantalum pentachloride (TaCl₅), etc.) is reacted with a reducing agent. The reducing agent may be provided in the form of a liquid, gas (e.g., hydrogen), or solid, such as a metal (e.g., sodium), metal alloy, or metal salt. In one embodiment, for instance, a tantalum salt (e.g., TaCl₅) may be heated at a temperature of from about 900° C. to about 2,000° C., in some embodiments from about 1,000° C. to about 1,800° C., and in some embodiments, from about 1,100° C. to about 1,600° C., to form a vapor that can be reduced in the presence of a gaseous reducing agent (e.g., hydrogen). Additional details of such a reduction reaction may be described in WO 2014/199480 to Maeshima, et al. After the reduction, the product may be cooled, crushed, and washed to form a powder.

The powder may be a free flowing, finely divided powder that contains primary particles. The primary particles of the powder generally have a median size (D50) of from about 0.07 μm to about 280 μm, in some embodiments from about 1 μm to about 250 μm, in some embodiments from about 5 μm to about 150 μm, and in some embodiments, from about 10 μm to about 100 μm, such as determined using a laser particle size distribution analyzer made by BECKMAN COULTER Corporation (e.g., LS-230), optionally after subjecting the particles to an ultrasonic wave vibration of 70 seconds. The particles may also have a Do particle size distribution (90 wt. % of the particles have a diameter below the reported value) of about 150 micrometers or less, of between about 0 and about 37 microns. The primary particles typically have a three-dimensional granular shape (e.g., nodular or angular). Such particles typically have a relatively low “aspect ratio”, which is the average diameter or width of the particles divided by the average thickness (“D/T”). For example, the aspect ratio of the particles may be about 4 or less, in some embodiments about 3 or less, and in some embodiments, from about 0.8 to about 1.5 (e.g., generally spherical). The valve metal powder may have a relatively high specific charge, such as about 20,000 μF*V/g or more, in some embodiments from about 30,000 to about 350,000 μF*V/g, in some embodiments from about 40,000 to about 200,000 μF*V/g, and in some embodiments, from about 45,000 to about 120,000 μF*V/g. The specific charge may be determined by multiplying capacitance by the anodizing voltage employed, and then dividing this product by the weight of the anodized electrode body.

Desirably, the porous anode body is formed from a powder that is substantially unagglomerated. Without intending to be limited by theory, it is believed that the use of such substantially unagglomerated powders can allow the resulting anode body to have a surface porosity that has a minimal degree of large pores (e.g., greater than 5 μm in size), thus improving the hermeticity of the anode body and the resulting anode component. By “substantially unagglomerated”, it is generally meant that the powder is not subjected to typical agglomeration techniques in which the primary particles are intentionally heated at a predetermined temperature (e.g., 0 to 40° C.) in the presence of a binder to agglomerate the powder. As a result, the substantially unagglomerated powder contains a majority of primary particles and lacks a significant portion of larger secondary particles that are often formed during agglomeration of the primary particles. Of course, it is possible that a small amount of agglomeration may occur during the course of normal processing conditions. Typically, however, at least about 50 wt. %, in some embodiments at least about 70 wt. %, and in some embodiments, from about 90 wt. % to 100 wt. % (e.g., 100 wt. %) of the powder remains unagglomerated.

If desired, the powder may be doped with sinter retardants in the presence of a dopant, such as aqueous acids (e.g., phosphoric acid). The amount of the dopant added depends in part on the surface area of the powder, but is typically present in an amount of no more than about 200 parts per million (“ppm”). The powder may also be subjected to one or more deoxidation treatments. For example, the powder may be exposed to a getter material (e.g., magnesium), such as described in U.S. Pat. No. 4,960,471. The temperature at which deoxidation of the powder occurs may vary, but typically ranges from about 700° C. to about 1,600° C., in some embodiments from about 750° C. to about 1,200° C., and in some embodiments, from about 800° C. to about 1,000° C. The total time of the deoxidation treatment(s) may range from about 20 minutes to about 3 hours. The resulting powder may have certain characteristics that enhance its ability to be used in a capacitor anode. For example, the powder typically has a specific surface area of from about 0.5 to about 10.0 m²/g, in some embodiments from about 0.7 to about 5.0 m²/g, and in some embodiments, from about 2.0 to about 4.0 m²/g. Likewise, the bulk density of the powder may be from about 0.1 to about 0.8 grams per cubic centimeter (g/cm³), in some embodiments from about 0.2 to about 0.6 g/cm³, and in some embodiments, from about 0.4 to about 0.6 g/cm³.

The manner in which the powder is applied to the anode substrate may vary as desired, such as printing (e.g., screen printing, stencil printing, etc.), coating, spraying, etc. If desired, the powder may be applied to the substrate as a “dry powder.” As used herein, the term “dry powder” means a powder having either no solvent or binder, or a limited amount of solvent or binder, involved in the material that is printed. In one embodiment, a dry powder corresponds to a powder having no substantial amount or only a negligible amount of any solvent therein. In another embodiment, a dry powder corresponds to a powder having a level of solvent or binder less than about 5.0% by weight of the total mass, less than about 2.0% by weight of the total mass of the composition, less than about 1.0%, less than about 0.5% or less than 0.1%. The elimination or reduction of solvents/binders relative to conventional pastes advantageously reduces cost and process steps, particularly for removal of such components by heating or other step during the manufacturing process. The use of dry powder also means that the purity of the powder will remain the same after sintering relative to conventional seeding techniques.

Of course, besides using a dry powder, it may also be desirable in certain embodiments to use a “paste.” Such a paste may be formed by combining the powder with a solvent. Any solvent of a variety of solvents may be employed, such as water; glycols (e.g., propylene glycol, butylene glycol, triethylene glycol, hexylene glycol, polyethylene glycols, ethoxydiglycol, and dipropyleneglycol); glycol ethers (e.g., methyl glycol ether, ethyl glycol ether, and isopropyl glycol ether); ethers (e.g., diethyl ether and tetrahydrofuran); alcohols (e.g., methanol, ethanol, n-propanol, iso-propanol, and butanol); triglycerides; ketones (e.g., acetone, methyl ethyl ketone, and methyl isobutyl ketone); esters (e.g., ethyl acetate, butyl acetate, diethylene glycol ether acetate, and methoxypropyl acetate); amides (e.g., dimethylformamide, dimethylacetamide, dimethylcaprylic/capric fatty acid amide and N-alkylpyrrolidones); nitriles (e.g., acetonitrile, propionitrile, butyronitrile and benzonitrile); sulfoxides or sulfones (e.g., dimethyl sulfoxide (DMSO) and sulfolane); and so forth. The total concentration of solvent(s) employed in the paste may vary but is typically from about 1 wt. % to about 40 wt. %, in some embodiments from about 5 wt. % to about 30 wt. %, and in some embodiments, from about 10 wt. % to about 20 wt. % of the paste. Of course, the specific amount of solvent(s) employed depends in part on the desired solids content and/or viscosity of the paste. For example, the solids content may range from about 40% to about 98% by weight, more particularly, between about 50% to about 96% by weight, and even more particularly, between about 60% to about 95% by weight. In addition to solvent(s), the paste may also include other components, such as adhesives, dispersants, surfactants, plasticizers, etc.

Regardless of how it is applied, the powder may be sintered before and/or after application to the substrate. Sintering typically occurs at a temperature of from about 700° C. to about 1,600° C., in some embodiments from about 800° C. to about 1,500° C., and in some embodiments, from about 900° C. to about 1,200° C., for a time of from about 5 minutes to about 100 minutes, and in some embodiments, from about 8 minutes to about 15 minutes. This may occur in one or more steps. If desired, sintering may occur in an atmosphere that limits the transfer of oxygen atoms to the anode. For example, sintering may occur in a reducing atmosphere, such as in a vacuum, inert gas, hydrogen, etc. The reducing atmosphere may be at a pressure of from about 10 Torr to about 2000 Torr, in some embodiments from about 100 Torr to about 1000 Torr, and in some embodiments, from about 100 Torr to about 930 Torr. Mixtures of hydrogen and other gases (e.g., argon or nitrogen) may also be employed.

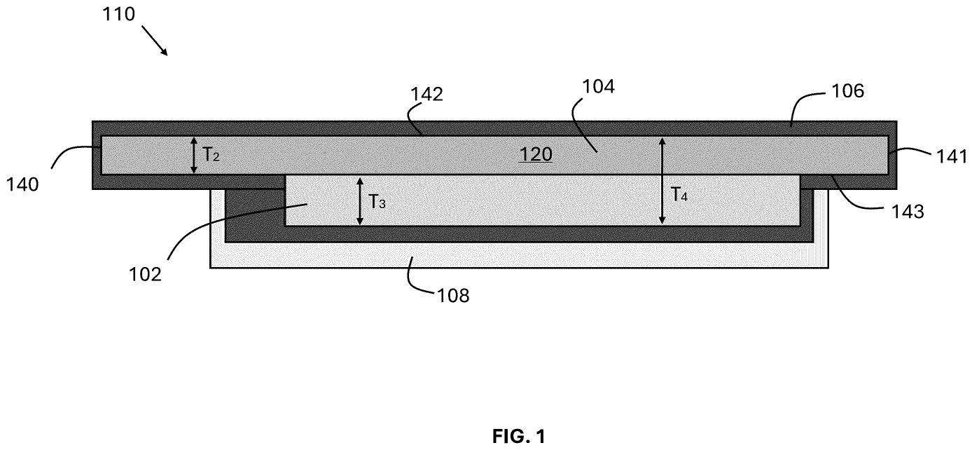

Referring to FIG. 1, one particular embodiment of an anode component 110 is shown in more detail that contains a porous anode body 102 deposited onto an anode substrate 104 as described herein. More particularly, the anode substrate 104 contains a lower surface 143 and opposing upper surface 142, first side surface 140 and opposing second side surface 141, and front surface 120 and/or opposing rear surface (not shown). In the illustrated embodiment, the anode substrate 104 is disposed on the lower surface 143 but this is by no means required. As discussed above, the height or thickness of the anode body 102 and the anode substrate 104 can be minimized such that the resulting solid electrolytic capacitor can have a low height profile to facilitate its use, for example, as an embedded passive component or microchip in a printed circuit board. The anode substrate 104 may, for example, have a thickness T₂ in the x-direction ranging of about 150 μm or less, in some embodiments from about 0.5 μm to about 120 μm, in some embodiments from about 1 μm to about 100 μm, and in some embodiments, from about 5 μm to about 50 μm. Likewise, the porous anode body may have a thickness T₃ in the x-direction of about 400 μm or less, in some embodiments from about 1 μm to about 200 μm, in some embodiments from about 5 μm to about 150 μm, in some embodiments from about 10 μm to about 120 μm, and in some embodiments, from about 15 μm to about 80 μm. As a result, the resulting anode component may thus have a total thickness T₄ in the x-direction of about 650 μm or less, in some embodiments 550 μm or less, in some embodiments 500 μm or less, in some embodiments from about 10 μm to about 300 μm, in some embodiments from about 20 μm to about 200 μm, and in some embodiments, from about 30 μm to about 150 μm.

### B. Dielectric

After formation of the anode component, a dielectric may be formed thereon. Typically, the dielectric is formed so that it is disposed over the porous anode body (e.g., on the surface and within the pores) for electrical communication with the solid electrolyte and cathode layer(s) as described in more detail below. Optionally, the dielectric may also be formed on one or more exposed surfaces of the anode substrate. Referring again to FIG. 1, for example, a dielectric 106 may be formed on and within the porous anode body 102 and on exposed region(s) of the anode substrate 104, such as exposed region(s) of the lower surface 143, upper surface 142, first side surface 140, second side surface 141, front surface 120, and/or rear surface (not shown). Depositing the dielectric onto the exposed surface(s) of the anode substrate can have a variety of benefits, such as helping to further seal and protect the substrate.

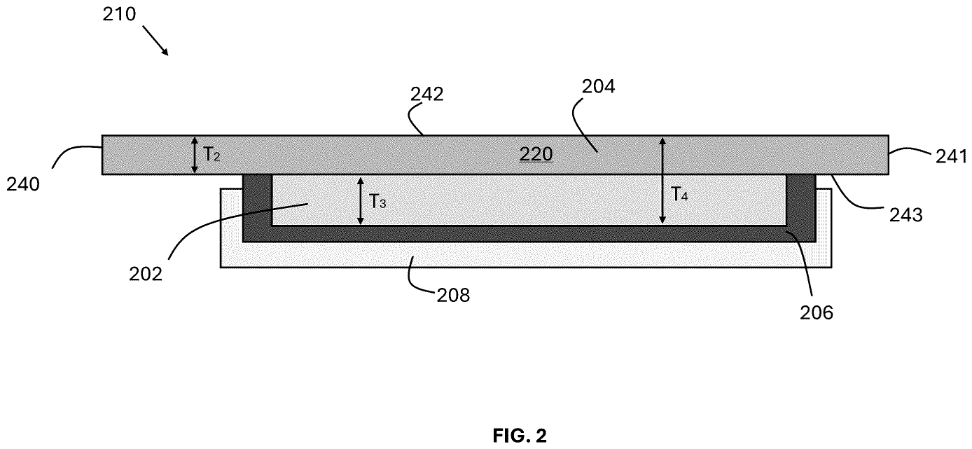

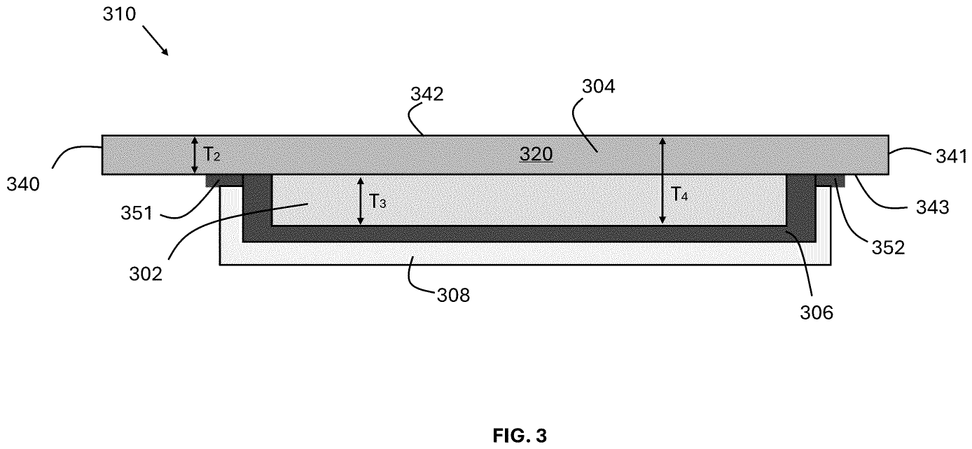

However, referring now to FIGS. 2-3, in some embodiments the dielectric is only formed on the porous anode body. For instance, as demonstrated by FIG. 2, one particular embodiment of an anode component 210 contains a porous anode body 202 deposited onto an anode substrate 204. The anode substrate 204 contains a lower surface 243 and opposing upper surface 242, first side surface 240 and opposing second side surface 241, and front surface 220 and/or opposing rear surface (not shown). As demonstrated by FIG. 2, the lower surface 243, the first side surface 240, the second side surface 241, and the opposing upper surface 242 are substantially free of the dielectric 206. Thus, as demonstrated by FIG. 2, in some embodiments the dielectric 206 may be formed surrounding the porous anode body 202.

As demonstrated by FIG. 3, one particular embodiment of an anode component 310 contains a porous anode body 302 deposited onto an anode substrate 304. The anode substrate 304 contains a lower surface 343 and opposing upper surface 342, first side surface 340 and opposing second side surface 341, and front surface 320 and/or rear surface (not shown). As demonstrated by FIG. 3, the lower surface 343, the first side surface 340, the second side surface 341, and the opposing upper surface 342 are substantially free of the dielectric 306. FIG. 3 demonstrates that in some embodiments the dielectric 306 can have two extending portions, 351 and 352, that cover a portion of the lower surface 343 to prevent the cathode coating 308 from contacting the anode substrate 304.

The manner in which the dielectric is formed may vary. In one embodiment, for example, the dielectric is formed by anodization. Anodization is an electrochemical process by which the anode component is oxidized to form a material having a relatively high dielectric constant. For example, the tantalum anode component may be anodized to tantalum pentoxide (Ta₂O₅). Typically, anodization is performed by initially applying an electrolyte to the anode component, such as by dipping at least a portion of the anode component (e.g., the entire anode component) into the electrolyte. The electrolyte is generally in the form of a liquid, such as a solution (e.g., acid or alkaline), dispersion, melt, etc. A solvent is generally employed in the electrolyte, such as described above. The solvent may constitute from about 50 wt. % to about 99.9 wt. %, in some embodiments from about 75 wt. % to about 99 wt. %, and in some embodiments, from about 80 wt. % to about 95 wt. % of the electrolyte. Although not necessarily required, the use of an aqueous solvent (e.g., water) is often desired to help achieve the desired oxide. In fact, water may constitute about 50 wt. % or more, in some embodiments, about 70 wt. % or more, and in some embodiments, about 90 wt. % to 100 wt. % of the solvent(s) used in the electrolyte.

The electrolyte is ionically conductive having any suitable range of ionic conductivities. Exemplary electrolytes may include metal salts, alkali salts, alkali salt mixed with a glycol, an acid mixed with an organic solvent, or phosphoric acid mixed with a glycol such as ethylene glycol. To enhance the ionic conductivity of the electrolyte, a compound may be employed that is capable of dissociating in the solvent to form ions. Suitable ionic compounds for this purpose may include, for instance, acids, such as nitric acid, sulfuric acid, phosphoric acid, polyphosphoric acid, boric acid, boronic acid, etc.; organic acids, including carboxylic acids, such as acrylic acid, methacrylic acid, malonic acid, succinic acid, salicylic acid, sulfosalicylic acid, adipic acid, maleic acid, malic acid, oleic acid, gallic acid, tartaric acid, citric acid, formic acid, acetic acid, glycolic acid, oxalic acid, propionic acid, phthalic acid, isophthalic acid, glutaric acid, gluconic acid, lactic acid, aspartic acid, glutaminic acid, itaconic acid, trifluoroacetic acid, barbituric acid, cinnamic acid, benzoic acid, 4-hydroxybenzoic acid, aminobenzoic acid, etc.; sulfonic acids, such as methanesulfonic acid, benzenesulfonic acid, toluenesulfonic acid, trifluoromethanesulfonic acid, styrenesulfonic acid, naphthalene disulfonic acid, hydroxybenzenesulfonic acid, dodecylsulfonic acid, dodecylbenzenesulfonic acid, etc.; polymeric acids, such as poly(acrylic) or poly(methacrylic) acid and copolymers thereof (e.g., maleic-acrylic, sulfonic-acrylic, and styrene-acrylic copolymers), carageenic acid, carboxymethyl cellulose, alginic acid, etc.; and so forth. The concentration of ionic compounds is selected to achieve the desired ionic conductivity. For example, an acid (e.g., phosphoric acid) may constitute from about 0.01 wt. % to about 5 wt. %, in some embodiments from about 0.05 wt. % to about 0.8 wt. %, and in some embodiments, from about 0.1 wt. % to about 0.5 wt. % of the electrolyte. If desired, blends of ionic compounds may also be employed in the electrolyte.

During anodization, a current is passed through the electrolyte to form the dielectric layer. When protic anodization electrolytes are utilized, the rate limiting nature of the anodization process allows for the management of the dielectric thickness through control of the anodization voltage. For example, the anodization power supply may be initially configured galvanostatically until the required voltage is attained, thereafter being switched to a potentiostatic control mode and maintaining the required voltage until the current passing through the electrolyte reaches a fractional value of the initial current achieved in the galvanostatic control mode. Dielectric thickness control can also be achieved through fixed soak times in the potentiostatic control mode. Other known methods may also be employed, such as pulse or step potentiostatic methods. Anodization voltages typically range from about 4 volts to about 250 volts, such as from about 5 volts to about 200 volts, such as from about 9 volts to about 100 volts. During anodization, the electrolyte may be kept at an elevated temperature, such as from about 30° C. to about 200° C., in some embodiments from about 40° C. to about 150° C., such as sin some embodiments from about 50° C. to about 100° C. Anodic oxidation may also be done at ambient temperature or lower.

In addition to anodization, the dielectric may also be formed by sequential vapor deposition, such as atomic layer deposition (ALD), molecular layer deposition (MLD), etc. Such processes typically involve the reaction of a precursor gaseous compound to form a metal oxide in situ on at least a portion of the anode component. The precursor compound may be provided in a gaseous state, which is then reacted in situ to deposit the metal oxide. The precursor compound may also be provided in a liquid or solid state, in which case it is generally vaporized into a gaseous compound and then reacted in situ to deposit the coating. Regardless, the anode component may be initially exposed to the gaseous precursor compound so that it reacts and bonds to the exposed surface without fully decomposing. Thereafter, a gaseous co-reactant (e.g., oxidant) may be exposed to the growth surface where it reacts with the deposited precursor compound. Once the reaction is complete, any remaining vapor byproducts may be removed (e.g., with an inert gas) and the anode component may then be subjected to additional sequential reaction cycles to achieve the target film thickness. One benefit of such a process is that the half-reactions are self-limiting. Namely, once the precursor compound has reacted with sites prepared during a previous co-reactant exposure, the surface reaction will stop because the surface sites prepared by the precursor reaction are reactive to the co-reactant, but not the precursor compound itself. This means that during steady state growth, the precursor compound will typically deposit at most only one monolayer (e.g., molecular fragment) during each half-reaction cycle even when the surface is exposed to the reactant species for a substantial period of time. Among other things, this allows the formation of a thin film coating that is conformal over the entire surface of the anode body, which in turn, can improve various properties of the capacitor.

The precursor compound may vary depending on the type of dielectric film that is employed. For example, the dielectric film typically contains a metal oxide, such as an oxide of tantalum (e.g., tantalum pentoxide, Ta₂O₅), oxide of niobium (niobium pentoxide, Nb₂O₅), etc. When forming a dielectric film containing an oxide of tantalum, for instance, a tantalum-containing gaseous precursor compound may be employed, including inorganic tantalum gaseous precursor compounds, such as tantalum halides (e.g., tantalum fluoride (TaF₅), tantalum chloride (TaCl₅), tantalum iodide (TaI₅), etc.); organic tantalum gaseous precursor compounds, such as tantalum alkoxides (e.g., tantalum methoxide (Ta(OCH₃)₅), tantalum ethoxide (Ta(OCH₂CH₃)₅), etc.), alkylamido tantalum compounds (e.g., pentakis(dimethylamido)tantalum, tris(diethylamido)(ethylimido)tantalum, tris(diethylamido)(tert-butylimido)tantalum (“TBTDET”), tert-butylimido-bis(diethylamido)cyclopentadienyl)tantalum (“TBDETCp”), etc.), etc.; as well as combinations of such compounds. Examples of these and other types of tantalum precursor compounds may be described in U.S. Pat. No. 7,030,042 to Vaartstra, et al.

The co-reactant may also vary depending on the particular type of reaction involved for forming the dielectric film. Typically, however, the co-reactant is a gaseous oxidizing agent that is capable of oxidizing the precursor compound (e.g., tantalum-containing precursor compound). Examples of suitable oxidizing agents for this purpose may include, for instance, water, oxygen, ozone, peroxides (e.g., hydrogen peroxide), alcohols (e.g., isopropanol), halides (e.g., CuCl₂, FeCl₃, FeBr₃, I₂, POBr₃, GeCl₄, SbI₃, Br₂, SbF₅, SbCl₅, TiCl₄, POCl₃, SO₂Cl₂, CrO₂Cl₂, S₂Cl, O(CH₃)₃SbCl₆, VCl₄, VOCl₃, BF₃, (CH₃(CH₂)₃)₂O·BF₃, (C₂H₅)₃O(BF₄), MoCl₅, BF₃·O(C₂H₅)₂ etc.), and so forth. In certain embodiments, it is desirable to employ a volatile oxidizing agent that has a relatively low boiling point so that the reaction temperatures can be maintained at a relatively level. For example, the oxidizing agent may have a boiling temperature of about 310° C. or less, in some embodiments about 300° C. or less, and in some embodiments, from about 80° C. to about 280° C.

To deposit the dielectric film, it is generally desirable to subject the anode component to multiple cycles within a reactor vessel. For instance, in a typical reaction cycle, a gaseous precursor compound may be supplied to a reactor vessel and allowed to react with the exposed surface of the anode body. A gaseous oxidizing agent may then be supplied to the vessel and allowed to oxidize the deposited precursor compound. Additional cycles may then be repeated to achieve the target thickness. In one embodiment, for instance, a reaction cycle is initiated by first heating the anode body to a certain deposition temperature. Although the particular deposition temperature for a given reaction cycle can vary based on a variety of factors, one particular benefit of the technique employed in the present invention is that relatively low temperatures can be employed. For example, the deposition temperature may be about 400° C. or less, in some embodiments about 350° C. or less, and in some embodiments, from about 150° C. to about 300° C. The reactor vessel pressure during deposition is also typically from about 0.2 to about 5 Torr, in some embodiments from about 0.3 to about 3 Torr, and in some embodiments, from about 0.6 to about 2 Torr (e.g., about 1 Torr). While at least a portion of the anode component is maintained at the deposition temperature and pressure, the gas precursor compound may be supplied to the reactor vessel via an inlet for a certain deposition time period and at a certain flow rate. The gas precursor flow rate can vary, but is typically from about 1 standard cubic centimeter per minute to about 1 liter per minute.

After reacting with the surface of the anode component, an inert gas (e.g., nitrogen, argon, helium, etc.) may be supplied to the reactor vessel to purge it from gases and vapor byproducts. A gaseous oxidizing agent may then be supplied to the reactor vessel through an inlet, which may be the same or different than the inlet used for the precursor compound. The oxidizing gas flow rate can vary, but is typically between about 1 standard cubic centimeter per minute to about 1 standard liter per minute. The temperature and/or pressure within the reaction vessel during deposition of the precursor compound and oxidizing agent may be the same or different, but is typically within the ranges noted above. As a result of a reaction cycle, such as described above, one or multiple layers of the dielectric film can form near the interface with the anode body and thus, are referred to herein as “interfacial” layer(s). As noted above, additional layers can also be formed on these interfacial layer(s) by utilizing one or more additional reaction cycles during which a precursor compound and oxidizing agent are sequentially supplied and react on the surface of the anode body.

Regardless of the technique employed, the resulting target dielectric thickness is about 20 nanometers (“nm”) or more, in some embodiments from about 40 nm to about 1,000 nm, in some embodiments from about 80 nm to about 800 nm, and in some embodiments, from about 100 nm to about 500 nm. As a result of such a dielectric, the resulting capacitor may exhibit a high “dielectric strength”, which generally refers to the ratio of the “breakdown voltage” of the capacitor (voltage at which the capacitor fails in volts, “V”) to the thickness of the dielectric (in nanometers, “nm”). For example, the capacitor typically exhibits a dielectric strength of about 0.6 V/nm or more, in some embodiments about 0.65 V/nm or more, in some embodiments about 0.7 V/nm or more, in some embodiments from about 0.7 to about 1 V/nm, and in some embodiments, from about 0.75 to about 0.9 V/nm. The breakdown voltage may, for example, be about 50 V or more, in some embodiments about 55 V or more, in some embodiments about 60 V or more, in some embodiments about 65 volts or more, in some embodiments about 70 V or more, in some embodiments about 80 V or more, and in some embodiments, from about 80 to about 150 V.

Referring again to FIG. 1, the dielectric 106 is disposed on a portion of an exposed region of the lower surface 143, the upper surface 142, side surfaces 140 and 141, front surface 120, and rear surface (not shown) of the anode substrate 104. In some embodiments, the exposed region of the lower surface 143, the upper surface 142, side surfaces 140 and 141, front surface 120, and rear surface (not shown) are entirely covered by the dielectric. However, it should be understood by one of ordinary skill in the art that the dielectric may be selectively applied or removed to various portions of the anode substrate.

For instance, referring again to FIG. 2, the anode substrate 204 is substantially free of the dielectric 206 in some embodiments, and thus the dielectric 206 only covers the porous anode body 202. In some embodiments, for instance, the anode substrate 204 may be free of the dielectric 206 at various portions due to either selectively applying the dielectric and/or later removing the dielectric once formed. Likewise, referring to FIG. 3, the anode substrate 304 may be free of dielectric 306 at various portions due to either selectively applying the dielectric and/or later removing the dielectric once formed. Without intending to be limited by theory, the present inventors have found that in some embodiments, having portions of the anode substrate substantially free of the dielectric allows for a better connection between the anode substrate with the anode connective member(s) and the anode terminals.

For instance, as demonstrated in FIG. 2, the dielectric 206 may optionally be removed using various techniques. In certain embodiments, the dielectric 206 may be subjected to a cleaning process in which at least a portion, if not all, of the dielectric 206 is removed from the anode substrate 204. In one embodiment, for instance, the dielectric 206 may be removed using a laser. In such embodiments, the anode substrate 204 is placed in contact with a laser beam at the locations in which it is desired to remove the dielectric. In one embodiment, the laser is one in which the laser medium includes an aluminum and yttrium garnet (YAG) doped with neodymium (Nd) and the excited particles are neodymium ions Nd³⁺. Such lasers typically emit light at a wavelength of about 1064 nanometers in the infrared spectrum. The laser may have any diameter suitable for the desired application. In some embodiments, the laser beam in the focused area has a diameter from about 0.05 mm to about 0.5 mm, in some embodiments from about 0.05 mm to about 0.3 mm, and in some embodiments from about 0.1 mm to about 0.15 mm. The laser may also include an optical head (e.g., lens), which as is well known in the art, primarily converges and focuses the laser beam to a focal point. The laser may also include a beam splitter.

In other embodiments, a masking material (not shown) may be applied to a portion of the anode substrate 204 prior to the formation of the dielectric 206 to prevent the dielectric 206 from forming on a portion of the anode substrate 204. In some embodiments, a masking material may be applied to a portion of an exposed region of the lower surface 243, the upper surface 242, side surfaces 240 and 241, front surface 220, and rear surface (not shown) of the anode substrate 204. In some embodiments, the exposed region of the lower surface 243, the upper surface 242, side surfaces 240 and 241, front surface 220, and rear surface (not shown) are entirely covered by the masking layer.

Any of a variety of known masking materials may generally be employed. For example, the masking material may include inorganic materials (e.g., Si3N4, silica, etc.), polymeric materials, organic resins (e.g., naphthalene), etc. Suitable polymeric masking materials may include, for instance, (meth)acrylic polymers, polyarylenes, polyorganosiloxanes, urethane polymers, polysulfones, ester resins, fluoropolymers, polyimides, etc. Suitable polymeric materials may include thermoplastic polymers that, for instance, have a melting temperature of from about 100° C. to about 300° C., in some embodiments from about 105° C. to about 200° C., and in some embodiments, from about 110° C. to about 180° C. In certain embodiments, the masking material is removable through an activation method suitable for the selected material. Examples of such activation methods include, for instance, melting the material, dissolving the material in a solvent, vaporizing the material, etc. The masking material may also be removed simply by dicing the capacitor assembly in such a manner that the masked portions of the anode substrate are removed. Of course, in other embodiments, it may be desired that the masking material is not removed.

### C. Precoat

Although by no means required, a pre-coat may optionally overly the dielectric. The material used in the pre-coat may vary, such as polymers (e.g., polyarylenes, polyorganosiloxanes, etc.), organometallic compounds, etc. Suitable organometallic compounds may, for instance, have the following general formula:

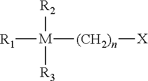

wherein,
M is an organometallic atom, such as silicon, titanium, and so forth;
R₁, R₂, and R₅ are independently an alkyl (e.g., methyl, ethyl, propyl, etc.) or a hydroxyalkyl (e.g., hydroxymethyl, hydroxyethyl, hydroxypropyl, etc.), wherein at least one of R₁, R₂, and R₃ is a hydroxyalkyl;
n is an integer from 0 to 8, in some embodiments from 1 to 6, and in some embodiments, from 2 to 4 (e.g., 3); and
X is an organic or inorganic functional group, such as glycidyl, glycidyloxy, mercapto, amino, vinyl, etc.

In certain embodiments, R₁, R₂, and R₃ may a hydroxyalkyl (e.g., OCH₃). In other embodiments, however, R₁ may be an alkyl (e.g., CH₃) and R₂ and R₃ may a hydroxyalkyl (e.g., OCH₃).

Further, in certain embodiments, M may be silicon so that the organometallic compound is an organosilane compound, such as an alkoxysilane. Suitable alkoxysilanes may include, for instance, 3-aminopropyltrimethoxysilane, 3-aminopropyltriethoxysilane, 3-aminopropylmethyldimethoxysilane, 3-aminopropylmethyldiethoxysilane, 3-(2-aminoethyl)aminopropyltrimethoxysilane, 3-mercaptopropyltrimethoxysilane, 3-mercaptopropyltriethoxysilane, 3-mercaptopropylmethyldimethoxysilane, 3-mercaptopropylmethyldiethoxysilane, glycidoxymethyltrimethoxysilane, glycidoxymethyltriethoxysilane, glycidoxymethyl-tripropoxysilane, glycidoxymethyltributoxysilane, β-glycidoxyethyltrimethoxysilane, β-glycidoxyethyltriethoxysilane, β-glycidoxyethyl-tripropoxysilane, β-glycidoxyethyl-tributoxysilane, β-glycidoxyethyltrimethoxysilane, α-glycidoxyethyltriethoxysilane, α-glycidoxyethyltripropoxysilane, α-glycidoxyethyltributoxysilane, γ-glycidoxypropyl-trimethoxysilane, γ-glycidoxypropyltriethoxysilane, γ-glycidoxypropyl-tripropoxysilane, γ-glycidoxypropyltributoxysilane, β-glycidoxypropyltrimethoxysilane, β-glycidoxypropyltriethoxysilane, β-glycidoxypropyltripropoxysilane, α-glycidoxypropyltributoxysilane, α-glycidoxypropyltrimethoxysilane, α-glycidoxypropyltriethoxysilane, α-glycidoxypropyl-tripropoxysilane, α-glycidoxypropyltributoxysilane, γ-glycidoxybutyltrimethoxysilane, δ-glycidoxybutyltriethoxysilane, δ-glycidoxybutyltripropoxysilane, δ-glycidoxybutyltributoxysilane, δ-glycidoxybutyltrimethoxysilane, γ-glycidoxybutyltriethoxysilane, γ-glycidoxybutyltripropoxysilane, γ-propoxybutyltributoxysilane, δ-glycidoxybutyltrimethoxysilane, δ-glycidoxybutyltriethoxysilane, δ-glycidoxybutyltripropoxysilane, α-glycidoxybutyltrimethoxysilane, α-glycidoxybutyltriethoxysilane, α-glycidoxybutyltripropoxysilane, α-glycidoxybutyltributoxysilane, (3,4-epoxycyclohexyl)-methyl-trimethoxysilane, (3,4-epoxycyclohexyl)methyl-triethoxysilane, (3,4-epoxycyclohexyl)methyltripropoxysilane, (3,4-epoxycyclohexyl)-methyl-tributoxysilane, (3,4-epoxycyclohexyl)ethyl-trimethoxysilane, (3,4-epoxycyclohexyl)ethyl-triethoxysilane, (3,4-epoxycyclohexyl)ethyltripropoxysilane, (3,4-epoxycyclohexyl)ethyltributoxysilane, (3,4-epoxycyclohexyl)propyltrimethoxysilane, (3,4-epoxycyclohexyl)propyltriethoxysilane, (3,4-epoxycyclohexyl)propyl-tripropoxysilane, (3,4-epoxycyclohexyl)propyltributoxysilane, (3,4-epoxycyclohexyl)butyltrimethoxysilane, (3,4-epoxycyclohexy)butyltriethoxysilane, (3,4-epoxycyclohexyl)butyltripropoxysilane, (3,4-epoxycyclohexyl)butyltributoxysilane, and so forth.

The particular manner in which the pre-coat is applied may vary as desired. In one particular embodiment, a precursor compound (e.g., organometallic compound) is dissolved in an organic solvent and applied to the part as a solution, such as by screen-printing, dipping, electrophoretic coating, spraying, etc. The organic solvent may vary, but is typically an alcohol, such as methanol, ethanol, etc. Precursor compound(s) may constitute from about 0.1 wt. % to about 10 wt. %, in some embodiments from about 0.2 wt. % to about 8 wt. %, and in some embodiments, from about 0.5 wt. % to about 5 wt. % of the solution. Solvent(s) may likewise constitute from about 90 wt. % to about 99.9 wt. %, in some embodiments from about 92 wt. % to about 99.8 wt. %, and in some embodiments, from about 95 wt. % to about 99.5 wt. % of the solution. Once applied, the part may then be dried to remove the solvent therefrom and form the pre-coat containing the precursor compound.

In other embodiments, the pre-coat may be formed by vapor deposition, such as described in more detail above. Such processes typically involve the polymerization of a gaseous precursor compound to form a coating in situ on the capacitor. The precursor compound may be provided in a gaseous state, which is then polymerized in situ to deposit a polymer coating. The precursor compound may also be provided in a liquid or solid state, in which case it is generally vaporized into a gaseous compound and then reacted in situ to deposit the coating. In certain embodiments, for instance, plasma-enhanced vapor deposition may be employed. Such a process is typically carried out in a reactor that generates a plasma, which may include ionized gaseous ions, electrons, atoms, and/or neutral species. The reactor typically includes a chamber, an optional vacuum system, and one or more energy sources, although any suitable type of reactor configured to generate a gas plasma may be used. The energy source may include any suitable device configured to convert one or more gases to a gas plasma, such as a heater, radio frequency generator, microwave generator, etc. To form the barrier film, the anode component may, for instance, be placed in the chamber of a reactor and a vacuum system may be used to pump the chamber down to pressures in the range of 10-3 to 10 mbar. One or more gases may then be pumped into the chamber and an energy source may generate the gas plasma. Thereafter, the precursor compound may be introduced into the gas plasma-containing chamber. When introduced in this manner, the precursor compound is typically ionized and/or decomposed to generate a range of active species in the plasma that generates the desired film structure. During such a process, the plasma drive frequency may be from 1 kHz to 1 GHZ, the plasma power may be from 100 to 250 W, the mass flow rate may be from 5 to 100 seconds per cubic centimeter (sccm), the operating pressure may be from 10 to 100 m Torr, and the coating time may be from 10 seconds to 20 minutes. Of course, one skilled in the art would readily understand that the particular conditions will be dependent on the size and geometry of the plasma chamber.

In yet other embodiments, a sequential vapor deposition may be employed in which a precursor compound and co-reactant are sequentially contacted with the surface of the capacitor element. Particularly suitable sequential techniques include, for instance, atomic layer deposition, molecular layer deposition, etc. The precursor compound used in such a deposition process may vary depending on the type of material that is employed. In one embodiment, for instance, the material may be a polymer, which is typically not electrically conductive. In one embodiment, for instance, the precursor compound may be a polyarylene compound having the following general structure:

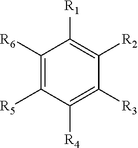

wherein,
   R₁ is alkyl, alkenyl, halo (e.g., chloro, fluoro, bromo, etc.), or haloalkyl (e.g., CF₂); and
R₂, R₃, R₄, R₅, and R₆ are independently selected from hydrogen, alkyl, alkenyl, halo, or haloalkyl, wherein one or more of R₁, R₂, R₃, R₄, R₅, or R₆ (e.g., R₁ and/or R₄) may be optionally bonded with another polyarylene ring (e.g., alkyl functional groups attached to the ring structure) to form a dimer. In certain embodiments, the alkyl may include linear or branched hydrocarbon radicals having 1 to 3 carbon atoms, and in some embodiments, 1 to 2 carbon atoms. Examples include methyl, ethyl, n-propyl and isopropyl. The alkenyl may likewise include linear or branched hydrocarbon radicals having 2 or 3 carbon atoms and a carbon-carbon double bond. One example is vinyl. For instance, R₁ may be methyl or vinyl (e.g., methyl), R₂ may be hydrogen, methyl or vinyl (e.g., hydrogen); R₃ may be hydrogen, methyl or vinyl (e.g., hydrogen); R₄ may be hydrogen, methyl or vinyl (e.g., hydrogen or methyl); R₅ may be hydrogen, methyl or vinyl (e.g., hydrogen); and/or R₆ may be hydrogen, methyl or vinyl (e.g., hydrogen). Particularly suitable paraylene compounds include, for instance, 1,4-dimethylbenzene (“paraxylylene” or “Paraylene N”), 1,3-dimethylbenzene, 1,2-dimethylbenzene, toluene, 4-methyl styrene, 3-methylstyrene, 2-methylstyrene, 1,4-divinylbenzene, 1,3-divinylbenzene, 1,2-divinylbenzene, chlorinated polyarylene (“Polyarylene C” or “Polyarylene D”), etc. As noted above, the polyarylene compound may also be a dimer in which one or more of the “R groups” of the arylene structure referenced above are bonded with a group of another arylene structure. One example of such a polyarylene dimer is [2,2]paracylcophane.

If desired, a co-reactant may also be employed to form the polymer film. For example, the co-reactant may be a fluorohydrocarbon, which is a hydrocarbon material comprising fluorine atoms. Particularly suitable fluorohydrocarbon compounds include, for instance, perfluoroalkanes, perfluoroalkenes, perfluoroalkynes, fluoroalkanes, fluoroalkenes, fluoroalkynes, etc. Typically, such compounds contain up to 10 carbon atoms, in some embodiments, up to five carbon atoms. Examples of such compounds include, for instance, CF₄, C₂F₄, C₂F₆, C₃F₆, C₃F₈, etc.

### D. Cathode Coating

The capacitor element also generally contains a cathode coating is disposed over the dielectric (including any optional pre-coat) and the porous anode body. The cathode coating includes a solid electrolyte, as well as other optional layers, such as carbon layer(s) (for protecting the solid electrolyte), metal particle layer(s) (e.g., for termination), oxidation-resistant layer(s), etc. The cathode coating may have a total thickness of about 200 μm or less, in some embodiments from about 0.5 μm to about 100 μm, in some embodiments from about 1 μm to about 80 μm, and in some embodiments, from about 5 μm to about 60 μm. As a result, the capacitor element, which includes the combination of the cathode coating, dielectric, and anode component, may thus have a total thickness of about 700 μm or less, in some embodiments from about 2 μm to about 400 μm, in some embodiments from about 20 μm to about 300 μm, and in some embodiments, from about 40 μm to about 220 μm.

The cathode coating is disposed on the porous anode body in such a manner that is it not placed into direct contact with the anode termination (positive termination) that electrically connects to the anode substrate. Thus, at least a portion of the anode substrate is generally free of the cathode coating to help maintain electrical isolation between positive and negative terminations of the capacitor. Referring again to FIG. 1, for instance, a cathode coating 108 may be disposed over the dielectric 106 at a location adjacent to the porous anode body 102. Optionally, a portion of the cathode coating 108 may also extend beyond the outer periphery of the anode body 102 as shown, but not over the entire length of the anode substrate 120. For example, at least a portion of the lower surface 143, upper surface 142, first side surface 140, first side surface 141, front surface 120, and rear surface (not shown) of the anode substrate 104 may remain free of the cathode coating 108. In fact, if desired, the entirety of the upper surface 142, first side surface 140, second side surface 141, front surface 120, and/or the rear surface may remain free of the cathode coating 108. In one embodiment, for instance, the cathode coating 108 is disposed only on a portion of the lower surface 143 of the anode substrate 104.

Referring again to FIG. 2, a cathode coating 208 may be disposed over the dielectric 206 at a location adjacent to the porous anode body 202. In one embodiment, for instance, the cathode coating 208 may be formed as to not extend beyond the length of the outer periphery of the anode body 202. Thus, the entirety of the lower surface 243, upper surface 242, first side surface 240, second side surface 241, front surface 240, and rear surface (not shown) may remain free of the cathode coating 208. Thus, when the cathode coating 208 is formed only on a portion of the dielectric 206 and the porous anode body 202, this prevents the cathode coating 208 from contacting the anode substrate 204, and thus the anode termination (positive termination) that electrically connects to the anode substrate 204.

FIG. 3 details one embodiment where the cathode coating 308 also does not contact the anode termination (positive termination) that electrically connects to the anode substrate 304. As demonstrated by FIG. 3, in one embodiment, the dielectric 306 may have extending portions 351 and 352 that cover a portion of the lower surface 343 of the anode substrate 304. Thus, the extending portions 351 and 352 prevent the cathode coating 308 from contacting the anode substrate 304. Therefore, as shown in FIG. 3, at least a portion of the lower surface 343, upper surface 342, first side surface 340, first side surface 341, front surface 320, and rear surface (not shown) of the anode substrate 304 may remain free of the cathode coating 308. In fact, if desired, the entirety of the upper surface 342, first side surface 340, second side surface 341, front surface 320, and/or the rear surface may remain free of the cathode coating 308.

i. Solid Electrolyte

The solid electrolyte generally contains conductive polymer particles that are disposed within the pores of the anode body. The conductive polymer particles may contain a conductive polymer (e.g., polyheterocycles, such as polypyrroles, polythiophenes, polyanilines, etc., polyacetylenes, poly-p-phenylenes, polyphenolates, etc.), and so forth. Thiophene polymers are particularly suitable for use in the solid electrolyte. In certain embodiments, for instance, a thiophene polymer may be employed that has repeating units of the following formula (I):

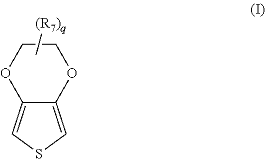

wherein,
R₇ is a linear or branched, C₁ to C₁₈ alkyl radical (e.g., methyl, ethyl, n- or iso-propyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl, n-octadecyl, etc.); C₅ to C₁₂ cycloalkyl radical (e.g., cyclopentyl, cyclohexyl, cycloheptyl, cyclooctyl, cyclononyl, cyclodecyl, etc.); C₆ to C₁₄ aryl radical (e.g., phenyl, naphthyl, etc.); C₇ to C₁₈ aralkyl radical (e.g., benzyl, o-, m-, p-tolyl, 2,3-, 2,4-, 2,5-, 2-6, 3-4-, 3,5-xylyl, mesityl, etc.); and
q is an integer from 0 to 8, in some embodiments, from 0 to 2, and in one embodiment, 0.

One commercially suitable example of 3,4-ethylenedioxthiophene is available from Heraeus under the designation Clevios™ M. Other suitable monomers are also described in U.S. Pat. No. 5,111,327 to Blohm, et al. and U.S. Pat. No. 6,635,729 to Groenendaal, et al. Derivatives of these monomers may also be employed that are, for example, dimers or trimers of the above monomers. Higher molecular derivatives, i.e., tetramers, pentamers, etc. of the monomers are suitable for use in the present invention. The derivatives may be made up of identical or different monomer units and used in pure form and in a mixture with one another and/or with the monomers. Oxidized or reduced forms of these precursors may also be employed.

To form the polymer, the precursor monomer may be polymerized in the presence of an oxidative catalyst (e.g., chemically polymerized). The oxidative catalyst typically includes a transition metal cation, such as iron(III), copper(II), chromium(VI), cerium(IV), manganese(IV), manganese(VII), or ruthenium(III) cations, and etc. A dopant may also be employed to provide excess charge to the conductive polymer and stabilize the conductivity of the polymer. The dopant typically includes an inorganic or organic anion, such as an ion of a sulfonic acid (e.g., p-toluene sulfonate). In certain embodiments, the oxidative catalyst has both a catalytic and doping functionality in that it includes a cation (e.g., transition metal) and an anion (e.g., sulfonic acid). For example, the oxidative catalyst may be a transition metal salt that includes iron(III) cations, such as iron(III) halides (e.g., FeCl₃) or iron (III) salts of other inorganic acids, such as Fe(ClO₄)₃ or Fe₂(SO₄)₃ and the iron (III) salts of organic acids and inorganic acids comprising organic radicals. Examples of iron (III) salts of inorganic acids with organic radicals include, for instance, iron (III) salts of sulfuric acid monoesters of C₁ to C₂₀ alkanols (e.g., iron (III) salt of lauryl sulfate). Likewise, examples of iron (III) salts of organic acids include, for instance, iron (III) salts of C₁ to C₂₀ alkane sulfonic acids (e.g., methane, ethane, propane, butane, or dodecane sulfonic acid); iron (III) salts of aliphatic perfluorosulfonic acids (e.g., trifluoromethane sulfonic acid, perfluorobutane sulfonic acid, or perfluorooctane sulfonic acid); iron (III) salts of aliphatic C₁ to C₂₀ carboxylic acids (e.g., 2-ethylhexylcarboxylic acid); iron (III) salts of aliphatic perfluorocarboxylic acids (e.g., trifluoroacetic acid or perfluorooctane acid); iron (III) salts of aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); iron (III) salts of cycloalkane sulfonic acids (e.g., camphor sulfonic acid); and so forth. Mixtures of these above-mentioned iron (III) salts may also be used. Iron (III)-p-toluene sulfonate, iron (III)-o-toluene sulfonate, and mixtures thereof, are particularly suitable. One commercially suitable example of iron (III)-p-toluene sulfonate is available from Heraeus under the designation Clevios™ C.

Typically, the conductive polymer particles are “pre-polymerized” in a manner prior to application to the anode. In one embodiment, for example, the pre-polymerized polymer is an intrinsically conductive polymer that has a positive charge located on the main chain that is at least partially compensated by anions covalently bound to the polymer. Such polymers may, for example, have a relatively high specific conductivity, in the dry state, of about 1 Siemen per centimeter (“S/cm”) or more, in some embodiments about 10 S/cm or more, in some embodiments about 25 S/cm or more, in some embodiments about 40 S/cm or more, and in some embodiments, from about 50 to about 500 S/cm. One example of a suitable intrinsically conductive thiophene polymer may have repeating units of the following formula (II):

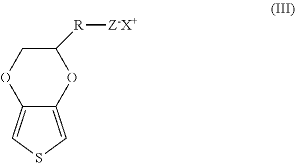

wherein,
R is (CH₂)ₐ—O—(CH₂)_{b}-L, where L is a bond or HC([CH₂]_{c}H);
a is from 0 to 10, in some embodiments from 0 to 6, and in some embodiments, from 1 to 4 (e.g., 1);
b is from 1 to 18, in some embodiments from 1 to 10, and in some embodiments, from 2 to 6 (e.g., 2, 3, 4, or 5);
c is from 0 to 10, in some embodiments from 0 to 6, and in some embodiments, from 1 to 4 (e.g., 1);
Z is an anion, such as SO₃₋, C(O)O—, BF₄, CF₃SO₃, SbF₆, N(SO₂CF₃)₂″, C₄H₃O₄, ClO₄, etc.;
X is a cation, such as hydrogen, an alkali metal (e.g., lithium, sodium, rubidium, cesium or potassium), ammonium, etc.

In one particular embodiment, Z in formula (III) is a sulfonate ion such that the intrinsically conductive polymer contains repeating units of the following formula (III):

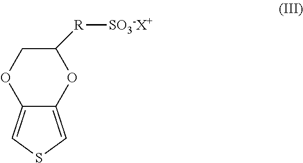

wherein, R and X are defined above. In formula (II) or (III), a is preferably 1 and b is preferably 3 or 4. Likewise, X is preferably sodium or potassium.

If desired, the polymer may be a copolymer that contains other types of repeating units. In such embodiments, the repeating units of formula (II) typically constitute about 50 mol. % or more, in some embodiments from about 75 mol. % to about 99 mol. %, and in some embodiments, from about 85 mol. % to about 95 mol. % of the total amount of repeating units in the copolymer. Of course, the polymer may also be a homopolymer to the extent that it contains 100 mol. % of the repeating units of formula (II). Specific examples of such homopolymers include poly(4-(2,3-dihydrothieno-[3,4-b][1,4]dioxin-2-ylmethoxy)-1-butane-sulphonic acid, salt) and poly(4-(2,3-dihydrothieno-[3,4-b][1,4]dioxin-2-ylmethoxy)-I-propanesulphonic acid, salt).

In another embodiment, the intrinsically conductive polymer has repeating thiophene units of the following general formula (IV):

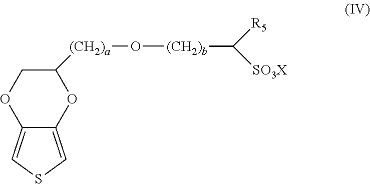

wherein,
a and b are as defined above;
R₅ is an optionally substituted C₁-C₆ linear or branched alkyl group (e.g., methyl) or a halogen atom (e.g., fluorine);
X is a hydrogen atom, an alkali metal (e.g., Li, Na, or K), NH(R¹)₃, or HNC₅H₅, wherein R₁ is each independently a hydrogen atom or an optionally substituted C₁-C₆ alkyl group.

Specific examples of thiophene compounds used to form such repeating are described in U.S. Pat. No. 9,718,905 and may include, for instance, sodium 3-[(2,3-dihydrothieno[3,4-b][1,4]dioxin-2-yl)methoxy]-1-methyl-1-propanesulfonate, sodium 3-[(2,3-dihydrothieno[3,4-b]-[1,4]dioxin-2-yl)methoxy]-1-ethyl-1-propanesulfonate, sodium 3-[(2,3-dihydrothieno[3,4-b]-[1,4]dioxin-2-yl)methoxy]-1-propyl-1-propane-sulfonate, sodium 3-[(2,3-dihydrothieno[3,4-b]-[1,4]dioxin-2-yl)methoxy]-1-butyl-1-propanesulfonate, sodium 3-[(2,3-dihydrothieno[3,4-b]-[1,4]dioxin-2-yl)methoxy]-1-pentyl-1-propane-sulfonate, sodium 3-[(2,3-dihydrothieno[3,4-b]-[1,4]dioxin-2-yl)methoxy]-1-hexyl-1-propanesulfonate, sodium 3-[(2,3-dihydrothieno[3,4-b]-[1,4]dioxin-2-yl)methoxy]-1-isopropyl-1-propanesulfonate, sodium 3-[(2,3-dihydrothieno[3,4-b]-[1,4]dioxin-2-yl)methoxy]-1-isobutyl-1-propanesulfonate, sodium 3-[(2,3-dihydrothieno[3,4-b]-[1,4]dioxin-2-yl)methoxy]-1-isopentyl-1-propanesulfonate, sodium 3-[(2,3-dihydrothieno[3,4-b]-[1,4]dioxin-2-yl)methoxy]-1-fluoro-1-propanesulfonate, potassium 3-[(2,3-dihydrothieno[3,4-b]-[1,4]dioxin-2-yl)methoxy]-1-methyl-1-propanesulfonate, 3-[(2,3-dihydrothieno[3,4-b]-[1,4]dioxin-2-yl)methoxy]-1-methyl-1-propanesulfonic acid, ammonium 3-[(2,3-dihydrothieno[3,4-b]-[1,4]dioxin-2-yl)methoxy]-1-methyl-1-propane-sulfonate, triethylammonium 3-[(2,3-dihydrothieno[3,4-b]-[1,4]dioxin-2-yl)methoxy]-1-methyl-1-propanesulfonate, etc., as well as combination thereof. Each of the above exemplified thiophene monomers may be prepared from thieno[3,4-b]-1,4-dioxin-2-methanol and a branched sultone compound in accordance with a known method (e.g., Journal of Electroanalytical Chemistry, 443, 217 to 226 (1998)).

“Extrinsically” conductive polymers may also be employed in the conductive polymer particles, which generally require the presence of a separate counterion that is not covalently bound to the polymer. One example of such an extrinsically conductive polymer is poly(3,4-ethylenedioxythiophene). The counterion may be a monomeric or polymeric anion that counteracts the charge of the conductive polymer. Polymeric anions can, for example, be anions derived from polymeric carboxylic acids (e.g., poly(meth)acrylic acids, such as poly-2-sulfoethyl(meth)acrylate or poly-3-propylsulfo(meth)acrylate; polymaleic acids; etc.); polymeric sulfonic acids (e.g., polystyrene sulfonic acids (“PSS”), polyvinyl sulfonic acids, etc.); and so forth, as well as salts thereof, such as an alkali metal, alkaline earth metal, transition metal, or ammonium salt thereof. Likewise, suitable monomeric anions may be derived from C₁ to C₂₀ alkane sulfonic acids (e.g., dodecane sulfonic acid); aliphatic fluorosulfonic acids (e.g., trifluoromethane sulfonic acid, perfluorobutane sulfonic acid, perfluorooctane sulfonic acid, trifluoromethanesulfonimide, etc.); aliphatic C₁ to C₂₀ carboxylic acids (e.g., 2-ethyl-hexylcarboxylic acid); aliphatic fluorocarboxylic acids (e.g., trifluoroacetic acid or perfluorooctanoic acid); aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); cycloalkane sulfonic acids (e.g., camphor sulfonic acid); boronic compounds (e.g., tetrafluoroboric acid); phosphoric compounds (e.g., hexafluorophosphoric acid); and so forth, as well as salts thereof, such as an alkali metal, alkaline earth metal, transition metal, or ammonium salt thereof. Particularly suitable counteranions are polymeric anions, such as those derived from a polymeric carboxylic or sulfonic acid (e.g., polystyrene sulfonic acid (“PSS”)). The molecular weight of such compounds typically ranges from about 1,000 to about 2,000,000, and in some embodiments, from about 2,000 to about 500,000.

Whether intrinsically or extrinsically conductive, pre-polymerized conductive polymer particles may be applied to the anode body in a variety of forms, such as a solution, dispersion, etc. Intrinsically conductive polymers, for example, are typically applied in the form of a solution and extrinsically conductive polymers are typically applied in the form of a dispersion.

When a solution is employed, the concentration of the polymer may vary depending on the desired viscosity of and the particular manner in which the layer is to be applied to the anode. Typically, however, the polymer constitutes from about 0.1 to about 10 wt. %, in some embodiments from about 0.4 to about 5 wt. %, and in some embodiments, from about 0.5 to about 4 wt. % of the solution. Solvent(s) may likewise constitute from about 90 wt. % to about 99.9 wt. %, in some embodiments from about 95 wt. % to about 99.6 wt. %, and in some embodiments, from about 96 wt. % to about 99.5 wt. % of the solution. While other solvents may certainly be employed, it is generally desired that water is the primary solvent such that the solution is considered an “aqueous” solution. In most embodiments, for example, water constitutes at least about 50 wt. %, in some embodiments at least about 75 wt. %, and in some embodiments, from about 90 wt. % to 100 wt. % of the solvent(s) employed. When employed, a solution may be applied to the anode using any known technique, such as dipping, casting (e.g., curtain coating, spin coating, etc.), printing (e.g., gravure printing, offset printing, screen printing, etc.), and so forth. The resulting conductive polymer layer may be dried and/or washed after it is applied to the anode.

When a dispersion is employed, the conductive polymer particles typically have an average size (e.g., diameter) of from about 1 to about 100 nanometers, in some embodiments from about 2 to about 80 nanometers, and in some embodiments, from about 4 to about 50 nanometers. The diameter of the particles may be determined using known techniques, such as by ultracentrifuge, laser diffraction, etc. The shape of the particles may likewise vary. In one particular embodiment, for instance, the particles are spherical in shape. However, it should be understood that other shapes are also contemplated by the present invention, such as plates, rods, discs, bars, tubes, irregular shapes, etc. The concentration of the particles in the dispersion may vary depending on the desired viscosity of the dispersion and the particular manner in which the dispersion is to be applied to the capacitor element. Typically, however, the particles constitute from about 0.1 to about 10 wt. %, in some embodiments from about 0.4 to about 5 wt. %, and in some embodiments, from about 0.5 to about 4 wt. % of the dispersion. The dispersion may also contain one or more binders, dispersion agents, fillers, surfactants, adhesives, etc. as is well known in the art. The dispersion may be applied using a variety of known techniques, such as by spin coating, impregnation, pouring, dropwise application, injection, spraying, doctor blading, brushing, printing (e.g., inkjet, screen, or pad printing), or dipping. The viscosity of the dispersion is typically from about 0.1 to about 100,000 mPas (measured at a shear rate of 100 s⁻¹), in some embodiments from about 1 to about 10,000 mPas, in some embodiments from about 10 to about 1,500 mPas, and in some embodiments, from about 100 to about 1000 mPas.

If desired, the solid electrolyte may be formed from multiple layers, such as inner and/or outer layers. The term “inner” in this context refers to one or more layers that overly the dielectric, whether directly or via another layer (e.g., pre-coat layer). The inner layer(s), for example, may contain an intrinsically conductive polymer and/or extrinsically conductive polymer as described above. In other embodiments, the inner layer(s) may contain a conductive polymer that is polymerized “in situ” using a polymerization process. In such an “in situ” process, as is well known in the art, an oxidative catalyst and precursor monomer may be applied either sequentially or together to initiate the polymerization reaction. One or multiple inner layers may be employed. For example, the solid electrolyte typically contains from 2 to 30, in some embodiments from 4 to 20, and in some embodiments, from about 5 to 15 inner layers (e.g., 10 layers). The solid electrolyte may contain only “inner layers” so that it is essentially formed from the same material. Nevertheless, in other embodiments, the solid electrolyte may also contain one or more optional “outer” conductive polymer layers that are formed from a different material than the inner layer(s) and overly the inner layer(s). For example, the inner layer(s) may be formed from an in-situ polymerized conductive polymer and/or solution of an intrinsically conductive polymer, while the outer layer(s) be formed from a dispersion of an extrinsically conductive polymer. In one particular embodiment, the outer layer(s) are formed primarily from such extrinsically conductive polymers in that they constitute about 50 wt. % or more, in some embodiments about 70 wt. % or more, and in some embodiments, about 90 wt. % or more (e.g., 100 wt. %) of a respective outer layer. One or multiple outer layers may be employed. For example, the solid electrolyte may contain from 2 to 30, in some embodiments from 4 to 20, and in some embodiments, from about 5 to 15 outer layers. The total thickness of the solid electrolyte can vary, but is typically from about 0.1 to about 50 μm, in some embodiments from about 0.5 to about 30 μm, and in some embodiments, from about 1 to about 20 μm.

ii. Metal Particle Layer

The cathode coating may also contain a metal particle layer that is disposed over the solid electrolyte and can serve as a termination layer for the cathode coating. The thickness of the metal particle layer can vary, but is typically from about 1 to about 60 μm, in some embodiments from about 2 to about 50 μm, and in some embodiments, from about 5 to about 40 μm.

The metal particle layer may include a plurality of conductive metal particles dispersed within a polymer matrix. The particles typically constitute from about 50 wt. % to about 99 wt. %, in some embodiments from about 60 wt. % to about 98 wt. %, and in some embodiments, from about 70 wt. % to about 95 wt. % of the layer, while the polymer matrix typically constitutes from about 1 wt. % to about 50 wt. %, in some embodiments from about 2 wt. % to about 40 wt. %, and in some embodiments, from about 5 wt. % to about 30 wt. % of the layer. The conductive metal particles may be formed from a variety of different metals, such as copper, nickel, silver, nickel, zinc, tin, lead, copper, aluminum, molybdenum, titanium, iron, zirconium, magnesium, etc., as well as alloys thereof. Silver is a particularly suitable conductive metal for use in the layer. The metal particles often have a relatively small size, such as an average size of from about 0.01 to about 50 micrometers, in some embodiments from about 0.1 to about 40 micrometers, and in some embodiments, from about 1 to about 30 micrometers. Typically, only one metal particle layer is employed, although it should be understood that multiple layers may be employed if so desired. The total thickness of such layer(s) is typically within the range of from about 1 μm to about 500 μm, in some embodiments from about 5 μm to about 200 μm, and in some embodiments, from about 10 μm to about 100 μm.

The polymer matrix typically includes a polymer, which may be thermoplastic or thermosetting in nature. Typically, however, the polymer is selected so that it can act as a barrier to electromigration of silver ions, and also so that it contains a relatively small amount of polar groups to minimize the degree of water adsorption in the cathode coating. In this regard, vinyl acetal polymers may be particularly suitable for this purpose, such as polyvinyl butyral, polyvinyl formal, etc. Polyvinyl butyral, for instance, may be formed by reacting polyvinyl alcohol with an aldehyde (e.g., butyraldehyde). Because this reaction is not typically complete, polyvinyl butyral will generally have a residual hydroxyl content. By minimizing this content, however, the polymer can possess a lesser degree of strong polar groups, which would otherwise result in a high degree of moisture adsorption and result in silver ion migration. For instance, the residual hydroxyl content in polyvinyl acetal may be about 35 mol. % or less, in some embodiments about 30 mol. % or less, and in some embodiments, from about 10 mol. % to about 25 mol. %.

To form the metal particle layer, a conductive paste is typically applied to the capacitor that overlies the solid electrolyte. One or more organic solvents are generally employed in the paste, such as discussed above. Once applied, the metal paste may be optionally dried to remove certain components, such as the organic solvents. For instance, drying may occur at a temperature of from about 20° C. to about 150° C., in some embodiments from about 50° C. to about 140° C., and in some embodiments, from about 80° C. to about 130° C.

iii. Carbon Layer

Although not required, the cathode coating may also contain other layers as is known in the art. In certain embodiments, for instance, a carbon layer (e.g., graphite) may be positioned between the solid electrolyte and the metal particle layer to help further limit contact of the metal particle layer with the solid electrolyte. The thickness of the carbon layer can vary, but is typically from about 0.1 to about 50 μm, in some embodiments from about 0.2 to about 30 μm, and in some embodiments, from about 0.5 to about 20 μm.

iv. Oxidation-Resistant Layer

If desired, the cathode coating may also contain an oxidation-resistant layer that overlies the solid electrolyte, metal particle layer, and/or carbon layer. Suitable oxidation-resistant materials may include, for instance, gold, platinum, brass, nickel, silver, copper, titanium, aluminum, zirconium, or alloys thereof. In one particular embodiment, the layer includes gold. The thickness of the oxidation-resistant layer can vary, but is typically from about 0.1 to about 10 μm, in some embodiments from about 0.2 to about 8 μm, and in some embodiments, from about 0.3 μm to about 5 μm.

### II. Terminations

The capacitor element may be electrically connected to an anode termination and cathode termination for subsequent integration into a circuit. More particularly, the anode termination is generally the positive termination and in electrical connection with the anode component (e.g., anode substrate) and the cathode termination is the negative termination and in electrical connection with the cathode coating.

The particular configuration of the terminations may depend on the intended application. In one embodiment, for example, the capacitor may be formed so that it is surface mountable, and yet still mechanically robust. For example, the anode component may be electrically connected to an external, surface mountable anode termination (e.g., pads, sheets, plates, frames, etc.) and the cathode coating may be electrically connected to an external, surface mountable cathode termination. The thickness or height of the terminations is generally selected to minimize the thickness of the capacitor. For instance, the thickness of the terminations may range from about 0.05 to about 1 millimeter, in some embodiments from about 0.05 to about 0.5 millimeters, and from about 0.1 to about 0.2 millimeters. Any conductive material may be employed to form the terminations, such as a conductive metal (e.g., gold, copper, nickel, silver, nickel, zinc, tin, palladium, lead, copper, aluminum, molybdenum, titanium, iron, zirconium, magnesium, tungsten and alloys thereof). In one embodiment, however, the conductive metal can be a metal that is resistant to oxidation, such as gold, palladium, or platinum. In an additional embodiment, the conductive material from which the anode termination and the cathode termination are formed can be applied via a thin layer deposition technique such as physical vapor deposition (PVD), chemical vapor deposition (CVD), or any other suitable technique. PVD and CVD can facilitate the deposition of a thin metal layer having a nanometer scale onto the cathode, which can further limit the height profile or thickness and enhance the volumetric efficiency of the solid electrolytic capacitor of the present invention. In another particular embodiment, the terminations can be in the form of a conductive paste, such as a silver polyimide paste that can be electroplated with nickel and a finish layer or a copper alloy conductive paste.

### III. Casing

The capacitor element may also be sealed within a casing such that at least a portion of the anode termination and cathode termination remain exposed for subsequent integration into a circuit. The casing may have a variety of different configurations. In one embodiment, for example, a conformal coating may be applied as a casing so that it covers one or more surfaces of the capacitor element. Examples of such conformal coatings include those containing ceramics (e.g., silica, alumina, alumina silicates, etc.), polymers (e.g., fluoropolymers, organopolysiloxanes, polyarylenes, polyimides, epoxy resins, etc.), and so forth. The capacitor element may also be sealed within a housing. Any of a variety of different materials may be used to form the housing, such as metals, plastics, ceramics, and so forth. In one embodiment, for example, the housing includes one or more layers of a metal, such as tantalum, niobium, aluminum, nickel, hafnium, titanium, copper, silver, steel (e.g., stainless), alloys thereof (e.g., electrically conductive oxides), composites thereof (e.g., metal coated with electrically conductive oxide), and so forth. In another embodiment, the housing may include one or more layers of a ceramic material, such as aluminum nitride, aluminum oxide, silicon oxide, magnesium oxide, calcium oxide, glass, etc., as well as combinations thereof.

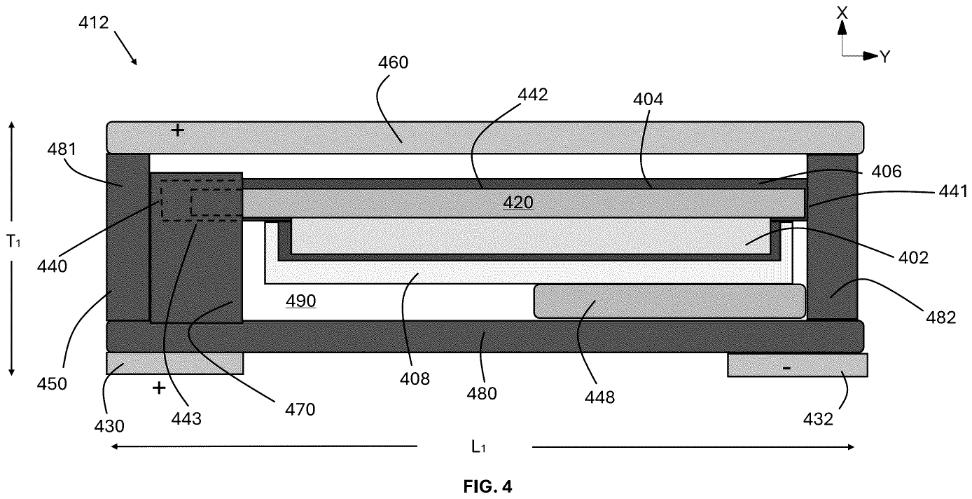

The housing may have any desired shape, such as cylindrical, D-shaped, rectangular, triangular, prismatic, etc. Referring to FIG. 4, for example, one embodiment of a capacitor 412 is shown that contains a housing 450 and a capacitor element that includes an anode substrate 404, porous anode body 402, dielectric 406, and cathode coating 408. In this particular embodiment, the housing 450 is generally rectangular. If desired, the capacitor may exhibit a relatively high volumetric efficiency to optimize its low profile. To facilitate such high efficiency, the capacitor element typically occupies a substantial portion of the volume of an interior cavity of the housing. For example, the capacitor element may occupy about 30 vol. % or more, in some embodiments from about 40 vol. % to about 90 vol. %, and in some embodiments, from about 50 vol. % to 85 vol. % of the interior cavity of the housing.

The capacitor element may be attached to the housing in such a manner that an anode termination and cathode termination are formed external to the housing for subsequent integration into a circuit. The particular configuration of the terminations may depend on the intended application. In certain embodiments, anode connective members may be employed within the interior cavity of the housing to facilitate connection to the terminations in a mechanically stable manner. For example, referring again FIG. 4, the capacitor 412 may include an anode connection member 470 that is formed from a conductive material(s) similar to the external terminations. The anode connective member 470 is “upstanding” in the sense that it is provided in a plane that is generally perpendicular the lateral direction in which the anode component extends (e.g., perpendicular to the −y direction). The anode connective member 470 may connect with the anode substrate 404 in a variety of different ways. For instance, in some embodiments, the anode connective member 470 may include a slot or a recessed portion (not shown) that may have a variety of different shapes and/or sizes. In certain embodiments, the slot has a “U-shape” that is configured to hold the anode substrate 404 for further enhancing surface contact and mechanical stability between the region of the anode substrate 404 that is free of the cathode coating 408 and the anode connective member 470.

Thus, the anode connective member can limit movement of the anode component in the horizontal direction to enhance surface contact and mechanical stability during use. Connection of the anode connective member 470 to the anode component 404 may be accomplished using any of a variety of known techniques, such as welding, laser welding, conductive adhesives, etc. Regardless of the technique chosen, however, the anode connective member 470 can hold the anode substrate 404 in substantial horizontal alignment to further enhance the dimensional stability of the capacitor element.

The anode connective member 470 may be connected to an anode termination in a variety of different ways. In the illustrated embodiment, for instance, the housing 450 includes a lower wall 480 and two opposing sidewalls 481 and 482 between which a cavity 490 is formed that includes the capacitor element. The lower wall 480 and sidewalls 481, 482 may be formed from one or more layers of a metal, plastic, or ceramic material such as described above. In this particular embodiment, the anode termination 430 is positioned external to the housing 450 and connected to the anode connective member 470 through a conductive trace (not shown) that extends through the lower wall 480. In addition to extending through the lower wall 480 of the housing 450, the trace may also be positioned at other locations, such as external to the outer wall. Of course, the present invention is by no means limited to the use of conductive traces for forming the desired terminations. Regardless of the particular configuration employed, connection of the anode termination 430 to the housing 450 may be made using any known technique, such as welding, laser welding, conductive adhesives, etc. In one particular embodiment, for example, a conductive adhesive (not shown) may be used to connect the anode termination 430 to the housing 450 (e.g., the lower wall 480). The conductive adhesives may be formed from conductive metal particles contained with a resin composition. The metal particles may be silver, copper, gold, platinum, nickel, zinc, bismuth, etc. The resin composition may include a thermoset resin (e.g., epoxy resin), curing agent (e.g., acid anhydride), and coupling agent (e.g., silane coupling agents). Suitable conductive adhesives are described in U.S. Patent Application Publication No. 2006/0038304 to Osako, et al.

The cathode coating 408 of the capacitor element may also be connected to a cathode termination 432. In one embodiment, for example, one or more conductive traces (not shown) may extend in the lower wall 480 of the housing 450 for electrical connection to the cathode coating 408. Connection of the cathode termination 432 to the housing 450 (e.g., lower wall 480) and the conductive trace(s) to the cathode coating 408 may be made using any known technique, such as welding, laser welding, conductive adhesives, etc. In one particular embodiment, for example, a conductive adhesive 448, such as described above, may be used to connect the cathode coating 408 to the conductive trace(s) extending through the housing 450. Similarly, a conductive adhesive (not shown) may also be used to connect the cathode termination 432 to the housing 450 (e.g., the lower wall 480).

Once connected in the desired manner, the resulting package may be sealed. In some embodiments, the package may be hermetically sealed, although hermetic sealing is not required. For instance, the housing 450 may also include a lid 460 that is placed on an upper surface of side walls 481 and 482 after the capacitor element is positioned within the housing 450. The lid 460 may be formed from a ceramic, metal (e.g., iron, copper, nickel, cobalt, etc., as well as alloys thereof), plastic, and so forth. If desired, a sealing member may be disposed between the lid 460 and the side walls 481, 482 to help provide a good seal. In one embodiment, for example, the sealing member may include a glass-to-metal seal, Kovar® ring (Goodfellow Camridge, Ltd.), etc. The height of the side walls 481, 482 is generally such that the lid 460 does not contact any surface of the capacitor element so that it is not contaminated. When placed in the desired position, the lid 460 is sealed to the sidewalls 481, 482 using known techniques, such as welding (e.g., resistance welding, laser welding, etc.), soldering, etc. Sealing may optionally occur in the presence of a gaseous atmosphere so that the resulting capacitor is substantially free of reactive gases, such as water vapor.

The thickness (or height) “T₁” of the capacitor 412 in the −x direction may be relatively low, such as about 1,000 micrometers (“μm”) or less, in some embodiments from about 1 μm to about 800 μm, in some embodiments from about 50 μm to about 750 μm, and in some embodiments, from about 100 μm to about 600 μm. The length L₁ of the capacitor 312 in the y-direction may vary but is typically from about 0.5 millimeters to about 5 millimeters, such as from about 0.75 millimeters to about 4 millimeters, such as from about 1 millimeter to about 3.75 millimeters, such as from about 2 millimeters to about 3.5 millimeters.

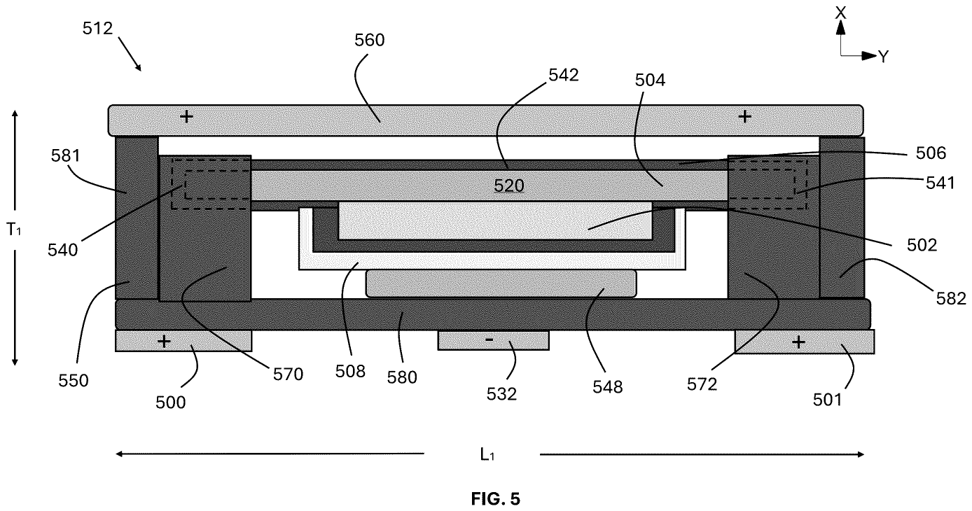

In the embodiment shown in FIG. 4, the capacitor 412 contains a single anode termination 430 (positive termination) and a single cathode termination 432 (negative termination). Of course, other configurations may also be employed depending on the desired product application. Referring to FIG. 5, for example, one embodiment of a capacitor 512 is shown that contains two anode terminations (i.e., first anode termination 500 and second anode termination 501) in combination with a single cathode termination 532. In this embodiment, for example, the capacitor 512 may include a first anode connective member 570 that is electrically connected to the first anode termination 500 and a second anode connective member 572 that is electrically connected to the second anode termination 501. The first anode connective member 570 and second anode connective member 572 may be similar in nature, construction, and electrical to the anode connective member 470 described above and shown in FIG. 4. To allow for connection of each member to their respective terminations, the capacitor element is constructed so that the porous anode body 502 and cathode coating 508 are disposed centrally between two respective ends of the anode substrate 502, which can both remain free of the cathode coating 508 in a manner such as described above. The cathode coating 508 of the capacitor element is thus connected to a cathode termination 532 in a manner similar to the embodiment described above and shown in FIG. 4.

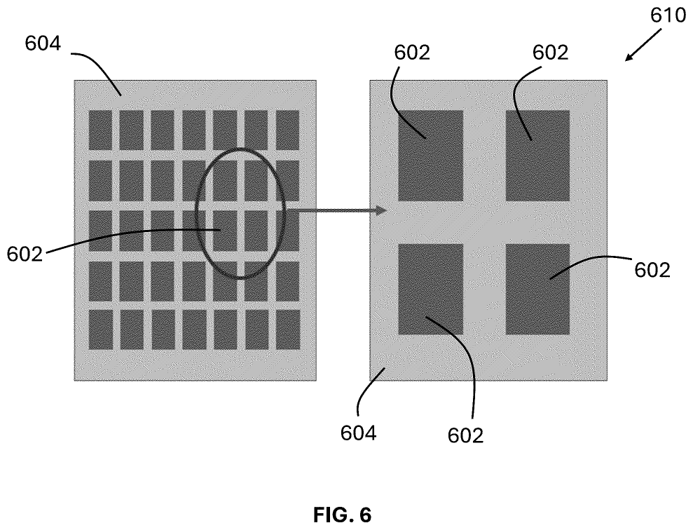

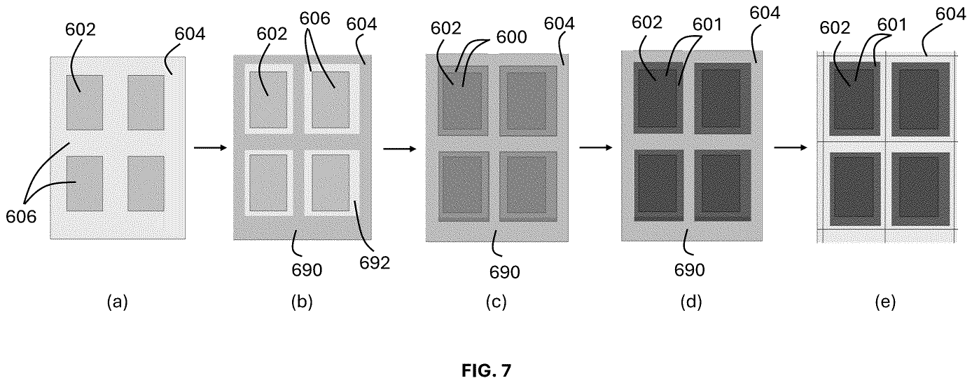

Various techniques may generally be employed to form the capacitor element and capacitor of the present invention. Referring to FIGS. 6-7, for example, one particular embodiment of a process that may be employed to form the capacitor element is shown in more detail. As shown in FIG. 6, for instance, an anode termination 610 may be formed by initially depositing discrete sections of a powder containing a valve metal composition (e.g., tantalum powder) onto a surface of an anode substrate 604 (e.g., foil). As discussed above, the powder may be applied as a “dry powder” or as a “paste” using a variety of techniques (e.g., printing). Regardless, before and/or after deposition, the powder may be sintered as described above to form a plurality of discrete porous anode bodies 602. As shown in Step (a) of FIG. 7, a dielectric 606 may thereafter be formed on and within the porous anode bodies 602, as well as on exposed region(s) of the anode substrate 604. In one embodiment, for example, the anode component may be dipped into an electrolyte solution and anodized in the manner described above to form the dielectric.

Once the dielectric 606 is formed, it is generally desired to apply a mask to certain sections of the anode substrate 604 to isolate the positive and negative terminations. In Step (b) of FIG. 7, for instance, a masking material 690 is initially applied to the anode substrate 604 in a predetermined pattern such that the porous anode bodies 602 are left exposed and unmasked. If desired, the predetermined pattern may be defined such that an area 692 of the anode substrate 604 surrounding the porous anode body 602 remains uncovered with the masking material 690 and thus left exposed for subsequent contact with a cathode coating. Any of a variety of known masking materials may generally be employed. For example, the masking material may include inorganic materials (e.g., Si₃N₄, silica, etc.), polymeric materials, organic resins (e.g., naphthalene), etc. Suitable polymeric masking materials may include, for instance, (meth)acrylic polymers, polyarylenes, polyorganosiloxanes, urethane polymers, polysulfones, ester resins, fluoropolymers, polyimides, etc. Suitable polymeric materials may include thermoplastic polymers that, for instance, have a melting temperature of from about 100° C. to about 300° C., in some embodiments from about 105° C. to about 200° C., and in some embodiments, from about 110° C. to about 180° C. In certain embodiments, the masking material is removable through an activation method suitable for the selected material. Examples of such activation methods include, for instance, melting the material, dissolving the material in a solvent, vaporizing the material, etc. The masking material may also be removed simply by dicing the capacitor assembly in such a manner that the masked portions of the anode substrate are removed. Of course, in other embodiments, it may be desired that the masking material is not removed. In one embodiment, for example, it may be desired to employ a “pre-coat” layer as described above (e.g., polyarylene) as the masking material.

Referring again to FIG. 7, after the masking material 690 is applied, a cathode coating is thereafter formed on the porous anode bodies 602 in Steps (c) and (d). In Step (c) of FIG. 7, for instance, one or more layers of a solid electrolyte 600 is formed on and within the pores of the anode bodies 602 and an any unmasked regions (i.e., region 692). The solid electrolyte may be applied using any of the techniques discussed above. The solid electrolyte 600 is also coated onto the masking material 690, which prohibits direct contact between the solid electrolyte 600 and the outer periphery of the anode substrate 602. In Step (d) of FIG. 7, other layers 601 of the cathode coating (e.g., carbon layer, metal particle layer, oxidation-resistant layer, etc.) are then applied in the same manner as described above. In the illustrated embodiment, the other layers 601 are deposited on the porous anode bodies 602 and not on the masking material 690, although this is by no means required. In Step (e) of FIG. 7, the masking material 690 may be removed from the anode substrate 604 and the resulting capacitor elements may be extracted by dicing the anode substrate 602 in a vertical and/or horizontal direction along the illustrated cut lines.

The following test procedures may be employed for determining one or more of the properties referenced herein.

### Test Procedures

### Leakage Current (“DCL”)

Leakage current may be measured using a leakage test meter at a temperature of 23° C.±2° C., with 1 kOhm resistor to limit charging current and at the rated voltage (e.g., 2.5 V) after a minimum of 60 seconds. DCL life testing may be conducted at a temperature of 105° C. and at a multiple of 1.0× the rated voltage for a time period of 5,000 hours. The size of the test group is typically 25 samples. During and after life testing, the aged samples may be allowed recover at room temperature for about 60 minutes. The “recovered” DCL may then be measured at a temperature of 23° C.+2° C. at the rated voltage for about 5 minutes. The period for intermediate “recovered” DCL measurement is typically 1,000 hours.

### Capacitance

Capacitance may generally be measured using a Keithley 3330 Precision LCZ meter with Kelvin Leads with 2.2 volt DC bias and a 0.5 volt peak to peak sinusoidal signal. The operating frequency may be 120 Hz and the temperature may be 23° C.±2° C. Measured unit is dried prior to the measurement at 125° C. for 30 minutes. Measurement is performed immediately after cool down to the temperature of the measurement.

### Wet Capacitance

The “wet capacitance” refers to the capacitance of the part after formation of the dielectric but before application of the solid electrolyte, graphite, and silver layers and it is measured in 14% nitric acid in reference to a 1 mF tantalum cathode with 2 volt DC bias and a 0.5 volt peak to peak sinusoidal signal after 30 seconds of electrolyte soaking.

### Equivalent Series Resistance (ESR)

Equivalence series resistance may be measured using a Keithley 3330 Precision LCZ meter with Kelvin Leads 2.2 volt DC bias and a 0.5 volt peak to peak sinusoidal signal. The operating frequency may 100 kHz and the temperature may be 23° C.±2° C. Measured unit is dried prior to the measurement at 125° C. for 30 minutes. Measurement is performed immediately after cool down to the temperature of the measurement.

### Breakdown Voltage (“BDV”)

The breakdown voltage may be determined using Keithley 2400 SourceMeter at the temperature 23° C.±2° C. An individual capacitor is charged with constant current determined by the equation:

$$Current ( A ) = Nominal Capacitance ( F ) \times dU / dt ,$$

where dU/dt represents the theoretical voltage slope typically set to 10 V/s. For example, the applied current may be set to 470 μA for unit with nominal capacitance 47 μF and theoretical voltage slope 10 V/s. The voltage is measured during charging and when the applied voltage decreases more than 10% from the highest achieved value, the maximum achieved voltage value is recorded as the “breakdown voltage” of each unit. At least ten (10) units are tested from one sample group and the minimum value is recorded as the “breakdown voltage.”

### Dielectric Thickness

The “dielectric thickness” (mm) may be measured using Zeiss Sigma FESEM at 20,000× to 50,000× magnification, wherein the sample is prepared by cutting a finished part in plane perpendicular to the longest dimension of the finished part, and the thickness is measured at sites where the cut is perpendicular through the dielectric layer. The average thickness value is recorded as the “dielectric thickness.”

### Dielectric Strength

The “dielectric strength” (V/mm) of a capacitor may be determined by dividing the breakdown voltage (minimum value recorded) by the dielectric thickness (average value recorded).

### Example 1

80,000 μFV/g tantalum powder paste was screen printed onto a tantalum foil (thickness 25 μm) and then sintered at 1310° C. The resulting pellets had a size of 2.6×2.0×0.05 mm. The pellets were anodized to 11 volts in water/phosphoric acid electrolyte with a conductivity of 4.3 mS/cm at temperature of 85° C. to form a dielectric layer. Upon anodization, a pre-coat layer of organometallic compound was applied that contained a solution of (3-aminopropyl) trimethoxysilane in ethanol (1.0%). A conductive polymer coating was formed by dipping the anodes into a solution of poly(4-(2,3-dihydrothieno-[3,4-b][1,4]dioxin-2-ylmethoxy)-1-butane-sulphonic acid having a solids content of 0.5% (Clevios™ K, Heraeus). Upon coating, the parts were dried at 125° C. for 15 minutes. This process was repeated 4 times. Thereafter, the parts were dipped into a dispersed poly(3,4-ethylenedioxythiophene) having a solids content 0.5% and viscosity 9 mPa·s (Clevios™ K, Heraeus). Upon coating, the parts were dried at 125° C. for 15 minutes. This process was repeated 8 times. Thereafter, the parts were dipped into a dispersed poly(3,4-ethylenedioxythiophene) having a solids content 1.0% and viscosity 13 mPa·s (Clevios™ K, Heraeus). Upon coating, the parts were dried at 125° C. for 15 minutes. This process was repeated 10 times. Thereafter, the parts were dipped into a dispersed poly(3,4-ethylenedioxythiophene) having a solids content of 2% and viscosity 160 mPa·s (Clevios™ K, Heraeus). Upon coating, the parts were dried at 125° C. for 15 minutes. This process was repeated 4 times. The parts were then coated with a graphite dispersion and dried. Finally, the parts were coated with a silver dispersion and dried. Multiple capacitor elements were made in this manner and measured.

### Example 2

Capacitor elements were formed in the manner described in Example 1, except that a 150,000 μFV/g tantalum powder paste was screen printed onto the foil and then sintered at 1240° C. Multiple capacitor elements were made in this manner and measured. The results are set forth in the table below.

| | Wet | Dry | Capacitance | |
|---|---|---|---|---|
| | Capacitance | Capacitance | recovery | ESR |
| | (μF) | (μF) | (%) | (Ohm) |
| Example 1 | 9.3 | 6.9 | 74 | 0.190 |
| Example 2 | 15.3 | 10.8 | 71 | 0.130 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A solid electrolytic capacitor having a thickness of about 1,000 μm or less, the capacitor comprising:
a capacitor element comprising:
an anode component comprising a porous anode body disposed on a surface of an anode substrate, wherein the anode substrate is formed from a valve metal composition and the porous anode body is formed from a sintered powder containing a valve metal composition, wherein the anode component has a thickness of about 650 μm or less;
a dielectric disposed over the porous anode body; and
a cathode coating disposed over the dielectric and the porous anode body, the cathode coating comprising a solid electrolyte containing conductive polymer particles, wherein at least a region of the anode substrate is free of the cathode coating;
an anode termination that is electrically connected to the region of the anode substrate that is free of the cathode coating;
a cathode termination that is electrically connected to the cathode coating; and
a casing that seals the capacitor element and leaves exposed at least a portion of the anode termination and the cathode termination.

2. The solid electrolytic capacitor of claim 1, wherein the anode substrate is generally planar.

3. The solid electrolytic capacitor of claim 2, wherein the anode substrate is a tantalum foil.

4. The solid electrolytic capacitor of claim 1, wherein the anode substrate has a thickness of about 150 μm or less.

5. The solid electrolytic capacitor of claim 1, wherein the powder contains primary particles having a median size of from about 0.07 μm to about 280 μm.

6. The solid electrolytic capacitor of claim 1, wherein the powder is substantially unagglomerated.

7. The solid electrolytic capacitor of claim 1, wherein the powder is a tantalum powder.

8. The solid electrolytic capacitor of claim 1, wherein the porous anode body has a thickness of about 400 μm or less.

9. The solid electrolytic capacitor of claim 1, wherein the dielectric is also disposed over a portion of the anode substrate.

10. The solid electrolytic capacitor of claim 9, wherein the anode substrate defines a lower surface and an opposing upper surface, opposing side surfaces, and a front surface and opposing rear surface, wherein the porous anode body is disposed on the lower surface of the anode substrate and the dielectric is disposed on a portion of an exposed region of the lower surface, upper surface, side surfaces, front surface, and rear surface of the anode substrate.

11. The solid electrolytic capacitor of claim 10, wherein the exposed region of the lower surface, upper surface, side surfaces, front surface, and rear surface of the anode substrate is entirely covered by the dielectric.

12. The solid electrolytic capacitor of claim 1, wherein a portion of the anode substrate is substantially free of the dielectric.

13. The solid electrolytic capacitor of claim 1, wherein the cathode coating has a thickness of about 200 μm or less.

14. The solid electrolytic capacitor of claim 1, wherein the capacitor element has a thickness of about 700 μm or less.

15. The solid electrolytic capacitor of claim 1, wherein the conductive polymer particles contain a thiophene polymer.

16. The solid electrolytic capacitor of claim 1, wherein the cathode coating further contains a metal particle layer containing silver particles dispersed within a polymer matrix.

17. The solid electrolytic capacitor of claim 1, wherein the cathode coating further contains an oxidation-resistant layer.

18. The solid electrolytic capacitor of claim 1, wherein the casing includes a conformal coating that covers one or more surfaces of the capacitor element.

19. The solid electrolytic capacitor of claim 1, wherein the casing is a housing that contains an interior cavity within which the capacitor element is received.

20. The solid electrolytic capacitor of claim 19, wherein the housing is formed from a metal, plastic, ceramic, or a combination thereof.

21. The solid electrolytic capacitor of claim 19, further comprising an anode connective member that is positioned within the housing in a direction that is generally perpendicular to a lateral direction of the anode component, wherein the anode connective member electrically connects the anode termination and the region of the anode substrate that is free of the cathode coating.

22. The solid electrolytic capacitor of claim 19, wherein an additional region of the anode substrate is free of the cathode coating, and wherein the capacitor comprises an additional anode termination that is electrically connected to the additional region of the anode substrate that is free of the cathode coating.

23. The solid electrolytic capacitor of claim 22, further comprising an additional anode connective member that is positioned within the housing in a direction that is generally perpendicular to a lateral direction of the anode component, wherein the additional anode connective member electrically connects the additional anode termination and the additional region of the anode substrate that is free of the cathode coating and the dielectric.

24. The solid electrolytic capacitor of claim 19, further comprising a conductive adhesive that is positioned within the housing and electrically connects the cathode termination to the cathode coating.

25. A method for forming a capacitor element having a thickness of about 700 μm or less, the method comprising:
depositing a tantalum powder onto a surface of an anode substrate and sintering the powder to form a porous anode body;
forming a dielectric over the porous anode body;
applying a masking material to the anode substrate in a predetermined pattern such that the porous anode body remains uncovered with the masking material; and
forming a cathode coating over the dielectric and the porous anode body such that at least a region of the anode substrate is free of the cathode coating, wherein the cathode coating comprises a solid electrolyte containing conductive polymer particles.

26. The method of claim 25, wherein the tantalum powder is a dry powder.

27. The method of claim 25, wherein the tantalum powder is in the form of a paste.

28. The method of claim 25, wherein the dielectric is also formed on a portion of an exposed region of the anode substrate.

29. The method of claim 28, wherein the exposed region of the anode substrate is entirely covered by the dielectric.

30. The method of claim 28, wherein a region of the dielectric is removed so that a portion of the exposed region of the anode substrate is substantially free of the dielectric.

31. The method of claim 25, wherein the predetermined pattern of the masking material is defined such that an area of the anode substrate surrounding the porous anode body remains uncovered with the masking material.

32. The method of claim 25, further comprising removing the masking material from the tantalum foil.

33. The method of claim 25, wherein the tantalum powder is substantially unagglomerated.
